(19) United States
(12) Patent Application Publication
(10) Pub. No.: US 2025/0182274 A1
(43) Pub. Date: Jun. 5, 2025

(54) QUANTIFYING CONSTITUENTS IN A SAMPLE CHAMBER USING IMAGES OF DEPTH REGIONS

(71) Applicant: IDEXX Laboratories, Inc., Westbrook, ME (US)

(72) Inventors: Jeremy Hammond, Standish, ME (US); Jason J. Aguiar, Freeport, ME (US); James W. Russell, North Yarmouth, ME (US)

(21) Appl. No.: 18/961,545

(22) Filed: Nov. 27, 2024

Related U.S. Application Data
(60) Provisional application No. 63/604,859, filed on Nov. 30, 2023.
(60) Provisional application No. 63/604,862, filed on Nov. 30, 2023.

(51) Int. Cl. G06T 7/00; G06T 7/571

(52) U.S. Cl. CPC G06T 7/0012; G06T 7/571; G06T 2207/10004; G06T 2207/10028; G06T 2207/10056; G06T 2207/30024

(57) ABSTRACT

An apparatus includes at least one processor and at least one memory storing instructions. The instructions, when executed by the processor(s), cause the apparatus to: determine that a sample chamber contains a first type of biological sample, where the sample chamber includes a bottom wall through which an imaging device can image the sample chamber; provide images by controlling the imaging device to, for each depth of a plurality of depths: focus on the respective depth, and capture one or more images containing the respective depth in the sample chamber; counting one or more constituents in the images to determine one or more depth distributions of the constituent(s) across the plurality of depths, where the constituent(s) include a constituent of interest; and quantifying the constituent of interest in the biological sample based on the one or more depth distributions and based on one or more depth distribution curves.

### CROSS-REFERENCE TO RELATED APPLICATIONS

This application claims the benefit of, and priority to, U.S. Provisional Patent Application No. 63/604,859, filed on Nov. 30, 2023 and U.S. Provisional Patent Application No. 63/604,862, filed on Nov. 30, 2023. The entire contents of each of the foregoing applications are hereby incorporated herein by reference.

### TECHNICAL FIELD

The present disclosure relates to imaging constituents of a biological sample, and more particularly, to quantifying constituents in a sample chamber using images for depth regions.

### BACKGROUND

Hematology analyzers can be utilized to count and identify blood cells. For example, hematology analyzers can detect and count different types of blood cells and can identify anomalies within blood samples. Manual microscopy is another approach for analyzing blood cells. Additionally, manual microscopy can be used to evaluate biological samples other than blood cells, as well.

### SUMMARY

In accordance with aspects of the present disclosure, an apparatus for analyzing a biological sample includes at least one processor and at least one memory storing instructions. The instructions, when executed by the at least one processor, cause the apparatus at least to perform: determining that a sample chamber contains a first type of biological sample, where the sample chamber includes at least one bottom wall through which an imaging device is configured to image the sample chamber; providing a plurality of images by controlling the imaging device to, for each depth of a plurality of depths in the sample chamber: focus on the respective depth, and capture one or more images of one or more fields of view containing the respective depth in the sample chamber; counting one or more types of constituents in the plurality of images to determine one or more depth distributions of the one or more types of constituents across the plurality of depths, where the one or more types of constituents include a constituent of interest; and quantifying the constituent of interest in the biological sample based on the one or more depth distributions and based on one or more depth distribution curves.

In accordance with aspects of the present disclosure, a method for analyzing a biological sample includes: determining that a sample chamber contains a first type of biological sample, where the sample chamber includes at least one bottom wall through which an imaging device is configured to image the sample chamber; providing a plurality of images by controlling the imaging device to, for each depth of a plurality of depths in the sample chamber: focus on the respective depth, and capture one or more images of one or more fields of view containing the respective depth in the sample chamber; counting one or more types of constituents in the plurality of images to determine one or more depth distributions of the one or more types of constituents across the plurality of depths, where the one or more types of constituents include a constituent of interest; and quantifying the constituent of interest in the biological sample based on the one or more depth distributions and based on one or more depth distribution curves.

In accordance with aspects of the present disclosure a processor-readable medium stores instructions which, when executed by at least one processor of an apparatus, causes the apparatus at least to perform: determining that a sample chamber contains a first type of biological sample, where the sample chamber includes at least one bottom wall through which an imaging device is configured to image the sample chamber; providing a plurality of images by controlling the imaging device to, for each depth of a plurality of depths in the sample chamber: focus on the respective depth, and capture one or more images of one or more fields of view containing the respective depth in the sample chamber; counting one or more types of constituents in the plurality of images to determine one or more depth distributions of the one or more types of constituents across the plurality of depths, where the one or more types of constituents include a constituent of interest; and quantifying the constituent of interest in the biological sample based on the one or more depth distributions and based on one or more depth distribution curves.

The details of one or more embodiments of the disclosure are set forth in the accompanying drawings and the description below. Other features, objects, and advantages of the techniques described in this disclosure will be apparent from the description and drawings, and from the claims.

### BRIEF DESCRIPTION OF THE DRAWINGS

A detailed description of embodiments of the disclosure will be made with reference to the accompanying drawings, wherein like numerals designate corresponding parts in the figures:

FIG. 1 is a diagram of example components of an apparatus or system, in accordance with aspects of the present disclosure;

FIG. 2 is an example of an image of red blood cells and a white blood cell, in accordance with aspects of the present disclosure;

FIG. 3 is an example of a fluorescence image of a white blood cell, in accordance with aspects of the present disclosure;

FIG. 4 is a diagram of an example of an imaging device with illuminators, in accordance with aspects of the present disclosure;

FIG. 5 is a diagram of an example of portions of a sample chamber, in accordance with aspects of the present disclosure;

FIG. 6 is a diagram of an example of a sample chamber and a column in the sample chamber, in accordance with aspects of the present disclosure;

FIG. 7 is a diagram of an example of depth regions in a column of a sample chamber, in accordance with aspects of the present disclosure;

FIG. 8 is a diagram of an example of deriving a depth distribution for a column of a sample chamber, in accordance with aspects of the present disclosure;

FIG. 9 is a diagram of an example of fitted curves for a column of a sample chamber, in accordance with aspects of the present disclosure;

FIG. 10 is a diagram of an example of reference curves for a column of a sample chamber, in accordance with aspects of the present disclosure;

FIG. 11 is a diagram of an example of further reference curves for a column of a sample chamber, in accordance with aspects of the present disclosure;

FIG. 12 is a diagram of an example of comparing a fitted curve to reference curves for a column of a sample chamber, in accordance with aspects of the present disclosure;

FIG. 13 is a diagram of an example of comparing a further fitted curve to reference curves for a column of a sample chamber, in accordance with aspects of the present disclosure;

FIG. 14 is a flow diagram of an example of an operation, in accordance with aspects of the present disclosure;

FIG. 15 is a diagram of an example of convolution processing, in accordance with aspects of the present disclosure;

FIG. 16 is a diagram of an example of one-dimensional kernels for the convolution processing of FIG. 15, in accordance with aspects of the present disclosure;

FIG. 17 is a diagram of an example of a combination of one-dimensional convolutions, in accordance with aspects of the present disclosure; and

FIG. 18 is a diagram of an example of components of a point-of-care apparatus, in accordance with aspects of the present disclosure.

### DETAILED DESCRIPTION

The present disclosure relates to quantifying constituents in a sample chamber using images for depth regions. In aspects, the present disclosure relates to imaging constituents of a biological sample that are slow to settle or that do not settle. In aspects, the present disclosure relates to reducing or avoiding double-counting or multiple counts of the same instance of a constituent in different images.

As used herein, the term “exemplary” does not necessarily mean “preferred” and may simply refer to an example unless the context clearly indicates otherwise. Although the disclosure is not limited in this regard, the terms “plurality” and “a plurality” as used herein may include, for example, “multiple” or “two or more.” The terms “plurality” or “a plurality” may be used throughout the specification to describe two or more components, devices, elements, units, parameters, or the like.

As used herein, the term “approximately,” when applied to a value, means that the exact value may not be achieved due to factors such as, for example, manufacturing imperfections and/or wear over time, among other factors.

As used herein, the term “imaging device” refers to and means any device that is configured to sense at least the visible light spectrum and to provide an image. An imaging device may include components such as, without limitation, one or more lenses and a sensor.

As used herein, the term “field of view” refers to and means a region that is capturable by an imaging device. The term “working distance” refers to and means the object to lens distance where the image is at its sharpest focus. An image can be said to be focused on a scene at the working distance. The term “depth of field” refers to and means the distance between the nearest and furthest elements in a captured image that appear to be acceptably in focus. Depth of field and what is considered “acceptable” focus will be understood in the field of optical imaging. The term “resolving power” refers to the smallest distance between two features that an imaging device can clearly present as being separate features.

As used herein, the term “dilution ratio” refers to and means a ratio of volume of diluent to volume of biological sample. Accordingly, a ratio of volume of diluent to volume of biological sample of 75:1 may be described as a dilution ratio of 75:1. A diluent may be and include any substance or combination of substances that can be combined with a biological sample, including, without limitation, reagents, stains, buffers, and/or working fluids, among other possible substances.

Flow cytometers and impedance analyzers commonly separate whole blood analyses into two separate subsamples. The first subsample will incorporate reagents that cause RBC to change shape from a biconcave disk to a sphere usually by a function of osmolality and surfactant. RBC and platelets (PLT) are commonly assessed during this sequence. The second subsample will incorporate reagents that lyse RBC (cause them to pop open and release the hemoglobin trapped within) and may stain white cells (e.g., nucleic acid stains). WBC and platelets are commonly assessed during this sequence.

These automated hematology analyzers separate the sample because of the vast difference in normal range for each of the cell types, as shown in Table 1 below. The reference intervals define the natural range in which a sample for the species is expected to fall. RBC are found on the order of millions per microliter of sample, PLT are found on the order of hundreds of thousands per microliter of sample, and WBC are found on the order of thousands to tens of thousands per microliter, so the relative prevalence of each is vastly different.

TABLE 1
Reference intervals for various species

| Parameter | Human | | Canine | | Feline | | Equine | |
|---|---|---|---|---|---|---|---|---|
| RBC | (4.64-6.03 | M/ul) | (5.65-8.87 | M/ul) | (6.54-12.2 | M/ul) | (6.4-10.4 | M/ul) |
| PLT | (176-408 | K/ul) | (148-484 | K/ul) | (151-600 | K/ul) | (100-250 | K/ul) |
| WBC | (4.34-10.15 | K/ul) | (5.05-16.76 | K/ul) | (2.87-17.02 | K/ul) | (4.9-11.1 | K/ul) |

Analysis of whole blood can provide technical difficulties since there are generally 1,000 red blood cells (RBC) for every white blood cell (WBC) in the sample. If a significant number of WBC are needed in order to determine the WBC subtypes (called the differential), then there will be a large number of total cells to evaluate. In flow cytometry and impedance analyses, this problem is addressed by separating a run into two segments—the first to identify RBC, and the second to identify WBC after removing RBC from the sample. Splitting the sample into a RBC and a WBC analysis is effective but requires two sets of reagents-one for each analysis.

Manual microscope evaluation is another approach for whole blood analysis. Microscope evaluation may provide different information (and possibly more information) about the cells than flow cytometry, such as morphologies of particular cells. When evaluating whole blood samples, it is important to be able to differentiate RBC, PLT, and WBC, and, if possible, to evaluate the five types of WBC that make up the differential, including neutrophils, lymphocytes, monocytes, eosinophils, and basophils. There are normal ranges for each of this five-part differential, and eosinophils and basophils can normally be nearly zero and are important to evaluate when they are elevated. For basophils, elevated levels can occur at very low percentage values of the total WBC value, requiring many WBC to be sampled in order to determine proportional values for each of the differential parameters with some statistical confidence. However, manual counts tend to only evaluate 100 or 200 cells, with 400 cells being a large number to manually count. This range reflects what is practical for human clinicians to manually count. The statistical confidence with only a few hundred cells is poor when evaluating cells that are less than 10% of the sample.

Manual microscope evaluation may also be used to analyze other biological samples, including ear cerumen, peripheral blood, fine needle aspirates, lavage fluids, body cavity fluids, semen, saliva, skin swabs, skin scrapes, fecal matter, and urine, among other possibilities. Each of these samples provides unique challenges when preparing glass slides to be analyzed. Each has varying viscosity, element concentration, and complicating interferences (e.g., lipids, wax, clumped cells/tissue, etc.). These factors, as well as technician skill, lead to frequent slide preparation difficulties and inconsistencies that can hinder efficacy of interpreting these samples via manual microscope evaluation. The most common problems with manual slide preparation are the lack of a true monolayer, mechanical damage to cells, lack of homogeneity, and poor or inconsistent staining. Additionally, in typical manual glass slide microscopy analysis, small element assessment can be challenging amongst larger elements that are in the same coincident space, such as bacteria and clumped cells/tissue, for example.

Aspects of the present disclosure relate to automated evaluation of a mixture of a biological sample with a diluent based on capturing images of the mixture by an imaging device and analyzing the captured images. In aspects, the present disclosure evaluates multiple constituents in the same analysis in order to reduce a clinician's workflow, reagent management, and run costs. In aspects, the multiple constituents include a constituent of interest that may settle slowly or may not settle within the mixture. Such constituents include, for example, lipids, platelets, and bacteria, among other possibilities. In aspects, the present disclosure relates to reducing or avoiding double-counting or multiple counts of the same instance of a constituent in different images.

Evaluation of biological samples where cells are mixed with a diluent generally involves an amount of time for gravity to cause the cells to settle to the bottom of a sample chamber and/or application of an external force, such as centrifugation, to cause more rapid settling. Settling rates of constituents depends on many factors, including size, shape, concentration, diluent specific gravity, and cell density, among other possible factors. For various settling conditions, cells near 5-micrometers in diameter and that are generally spherical in a nearly isotonic solution will settle at a rate near 1-micrometer per second. When the cells in the sample have different sizes and include small cells (e.g., less than 3-micrometers in diameter), the smaller cells will tend to settle much slower than the larger cells. Also, certain types of cells will remain neutrally buoyant or even float to the top if their density is low enough that the buoyant forces match or exceed gravitational forces in the diluted sample media.

Two examples where smaller cells settle slowly or do not settle include whole blood samples and samples containing bacteria.

For whole blood samples, the majority of cells in the sample will be red blood cells, as mentioned above. RBCs are roughly spherical, and their size vary depending on the animal species. For many species, RBC diameter will be roughly 5-micrometers. Platelets will be the next most common cell type and have a diameter generally less than 3-micrometers (different species have different ranges of platelet size). Platelets are generally 15-times less numerous than red blood cells in a typical sample. For a sample chamber that has a depth dimension of 100-micrometers, one could expect roughly all red blood cells to settle to the bottom of a sample chamber in under two minutes (assuming a settling rate of 1-micrometer per second). In this case, it would be common for the platelets to just partially settle since their settling rate is much slower. Thus, platelets in a whole blood sample settle slowly and may be evaluated in various ways described below herein.

For a biological sample containing cells, debris, and bacteria, the cells (likely white blood cells) would settle rapidly since they are generally 6-10 micrometers in diameter and will settle faster than 1-micrometer per second. Bacteria and debris tend to be on the order of 1-micrometer in diameter and will settle at a relatively slower rate or will not settle. Thus, bacteria in a biological sample settle slowly and may be evaluated in various ways described below herein.

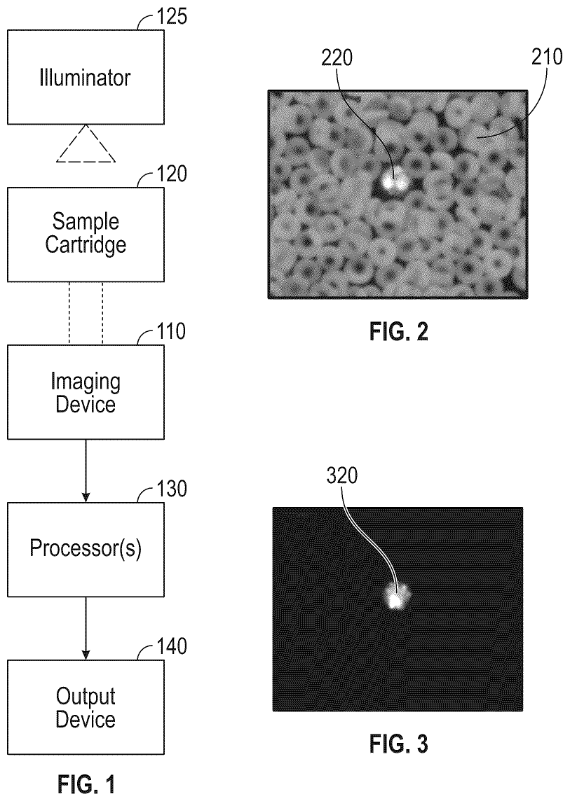

Referring to FIG. 1, a block diagram of various components is shown. The components include an imaging device 110, a sample cartridge 120, an illuminator 125, one or more processor(s) 130, and an output device 140. In embodiments, the components 110-140 may be co-located in a single apparatus, such as in a point-of-care apparatus of a veterinary clinic. In embodiments, one or more of the components may be located in different systems or devices. For example, one or more of the processor(s) 130 may be a processor in a cloud system. In embodiments, the components may include a communication device (not shown) for communicating information between different systems or devices.

The imaging device 110 is configured to capture a field of view containing at least a portion of the sample cartridge 120. In particular, the sample cartridge 120 includes a sample chamber, and the imaging device 110 captures a field of view containing at least a portion of the sample chamber. The sample chamber is illuminated by the illuminator 125, which may include a brightfield illuminator and/or a light source which induces Stokes shift and causes, e.g., stained RNA, stained DNA, stained antibody, or other stained targets, to fluoresce. An example of a light source which induces Stokes shift and causes stained WBCs to fluoresce is a blue light LED (light emitting diode) or an ultraviolet light LED. Such light sources may be implemented using a brightfield illuminator together with one or more filters configured to pass only blue light. Known staining methods may be used in order to cause RNA, DNA, antibodies, and/or other targets in, e.g., WBCs, nucleated RBC, reticulocytes, Heinz bodies, Howell-Jolly bodies, platelets, and/or bacteria, to fluoresce. In embodiments, the illuminator 125 may be positioned relative to the sample cartridge 120 in different ways and may include separate components that have different positions relative to the sample cartridge.

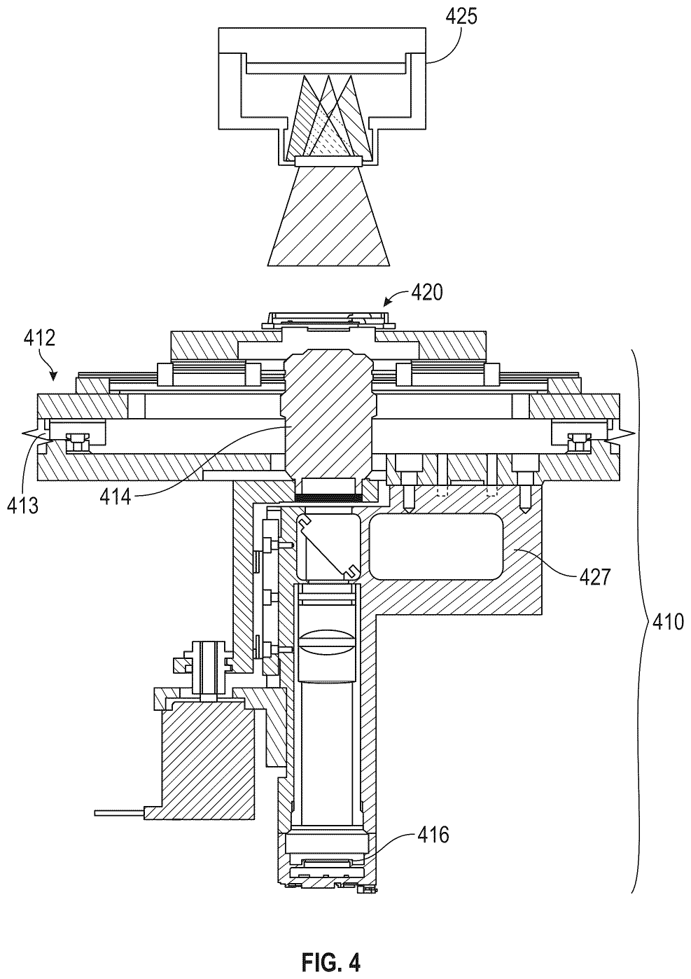

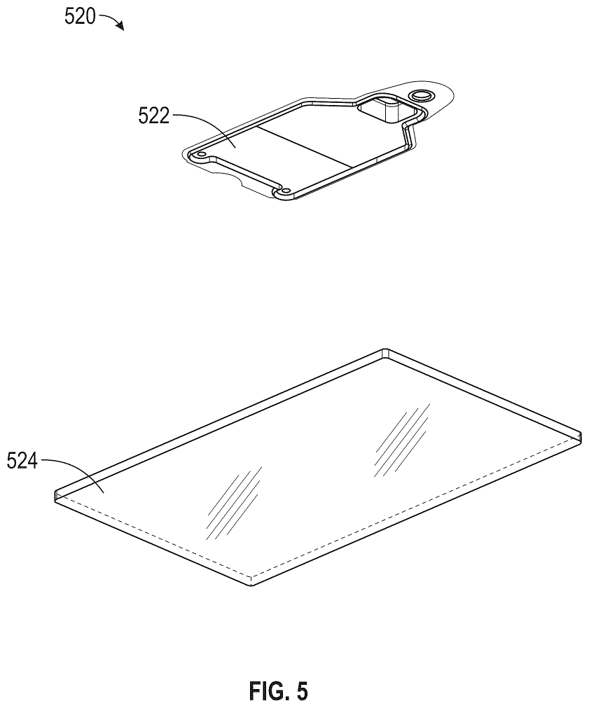

In embodiments, the sample cartridge 120 is movable to enable the imaging device 110 to capture different fields of view containing at least a portion of the sample chamber. In embodiments, rather than the sample cartridge 120 moving, the imaging device 110 is movable to capture different fields of view containing at least a portion of the sample chamber. An example of the imaging device 110 will be described in more detail in connection with FIG. 4, and an example of the sample cartridge 120 will be described in more detail in connection with FIG. 5.

Capturing multiple fields of view will be described in more detail later herein. For now, it is sufficient to note that each field of view captures at least a portion of the sample chamber of the sample cartridge 120. In embodiments, an entire cross-sectional area of a sample chamber of the sample cartridge 120 corresponds to more than one-hundred fields of view, such as in the range of two-hundred to four-hundred fields of view, among other possibilities. In embodiments, the entire cross-sectional area of the sample chamber in the sample cartridge 120 corresponds to less than one-hundred fields of view. In embodiments, the imaging device 110 and/or the sample cartridge 120 move at a rate such that between fifty to one-hundred different fields of view are captured each minute. In embodiments, other rates of capturing fields of view are within the scope of the present disclosure.

With continuing reference to FIG. 1, the processor(s) 130 are configured to analyze the images captured by the imaging device 110. As an example, in embodiments where the illuminator 125 is a brightfield illuminator and the biological sample is a whole blood sample, any RBCs in the images would appear in color and any WBCs in the images would appear in a different color. As another example, in embodiments where the illuminator 125 is a light source that induces Stokes shift and causes any stained WBCs to fluoresce without causing any RBCs to fluoresce, the images would only show the fluorescing WBCs. In embodiments, the illuminator 125 contains a brightfield illuminator as well as a light source that causes fluorescence. In embodiments, brightfield images and fluorescence images may be combined to provide composite images.

FIG. 2 shows an example of a composite image generated based on multiple brightfield and fluorescent images and is shown in grayscale rather than in color. In the image of FIG. 2, red blood cells 210 appear in one color (e.g., red), while a white blood cell 220 appears in another color (e.g., bluish). In embodiments such as FIG. 2, the processor(s) 130 may identify WBCs in the images by their color and/or by their shape. Various ways of doing so include, without limitation, applying one or more trained machine learning models (e.g., convolutional neural network) that are trained to perform object detection to detect WBCs and/or detect various types of WBCs, i.e., neutrophils, lymphocytes, monocytes, eosinophils, and/or basophils.

FIG. 3 shows an example of a single fluorescent image (shown in grayscale) in which RBC do not fluoresce, so the image shows only the fluorescing WBC 320 but no RBCs. In embodiments such as FIG. 3, the processor(s) 130 may identify WBCs in the images by their mere presence and/or by their shape. Various ways of doing so include, without limitation, applying one or more trained machine learning models (e.g., convolutional neural network) that are trained to perform object detection to detect WBCs and/or detect various types of WBCs, i.e., neutrophils, lymphocytes, monocytes, eosinophils, and/or basophils.

The examples of FIG. 2 and FIG. 3 are merely illustrative. In embodiments, other constituents (e.g., bacteria, platelets, lipids, etc.) may be imaged by brightfield imaging and/or fluorescence imaging, and machine learning models and/or image analytics may be applied to detect one or more constituents in such images. In embodiments, brightfield images and fluorescence images may be combined to provide composite images. In embodiments, other types of images are contemplated to be within the scope of the present disclosure.

With continuing reference to FIG. 1, the processor(s) 130 count number of WBCs in the images and, optionally, may count number of RBCs or platelets in the images, among other possible constituents, such as lipids, platelets, and/or bacteria. In embodiments, the processor(s) 130 may also apply machine learning models and/or image analytics to detect RBCs, platelets, and/or other constituents. In embodiments, the processor(s) 130 may also apply machine learning models and/or image analytics to detect various WBC morphologies, such as left shift (immature neutrophils), toxic change, reactive lymphocytes, among other morphologies. Known methods can be used to implement such machine learning models and/or image analytics.

The processor(s) 130 causes the output device 140 to provide information regarding various constituents to a person or user, such as number of constituents counted and/or detected morphologies, among other possible information. The output device 140 may be any output device capable of communicating information to a person or user. In embodiments, the output device 140 is a display panel of a point-of-care device and is in the same device as the other components 110-130. In embodiments, the output device 140 may be an office computer or smartphone of a clinician, and a network device (not shown) may communicate the WBC information to the office computer or smartphone for display. For example, the processor(s) 130 may cause a text message or an email, that contains the information, to be sent, and the output device 140 may receive and display the text message or email to a user. Other types of output devices 140 are contemplated to be within the scope of the present disclosure, such as audio output devices, among other possibilities.

FIG. 1 is merely an example of some components of an apparatus. It should be understood that an apparatus will include other components not shown in FIG. 1, such as a power supply, memory, electronic storage, network device, and/or other components. Such components, and other variations of an apparatus, are contemplated to be within the scope of the present disclosure.

Referring now to FIG. 4, there is shown an example of an imaging device 410, a sample cartridge 420, a brightfield illuminator 425, and one or more light sources 427 that induce Stokes shift. In the illustrated embodiment of FIG. 4, portions of the imaging device 410 and of the light source(s) 427 are integrated into a common housing. The brightfield illuminator 425 illuminates the sample cartridge 420 from above, and the light source(s) 427 illuminate that sample cartridge 420 from below. The brightfield illuminator 425 and the light source(s) 427 are controlled by a processor (e.g., 130, FIG. 1) to turn on or off at desired times to illuminate the sample cartridge 420. In embodiments, the light source(s) 427 may be separate from the imaging device 410. In embodiments, the brightfield illuminator 425 and the light source(s) 427 may be positioned and oriented differently than as shown in FIG. 4.

The imaging device 410 includes a positioning mechanism for positioning the sample cartridge 420 above a camera lens assembly 414 of the imaging device 410. The camera lens assembly 414 includes at least one lens and has a configured field of view, depth of field, resolving power, and magnification, among other characteristics. In embodiments, the camera lens assembly 414 provides a fixed optical magnification, such as 10×, 20×, or 40× optical magnification or another optical magnification, which enables the imaging device 410 to function as a microscope. In embodiments, the camera lens assembly 414 provides an adjustable magnification.

The positioning mechanism includes a platform 412 and includes motors 413 which move the platform 412. In the illustrated embodiment, the camera lens assembly 414 is stationary, and the positioning mechanism is capable of moving the sample cartridge 420 in two or three orthogonal directions (e.g., X and Y directions, optionally Z direction) to enable the camera lens assembly 414 to capture different fields of view containing at least a portion of the sample cartridge 420. The X- and Y-directions support moving to different fields of view, and the Z-direction supports changes to the depth level at end of the working distance.

Light from the field of view captured by the camera lens assembly 414 is directed to a sensor 416 through various optical components, such as a dichroic mirror and a lens tube, among other possible optical components. The sensor 416 may be a charge coupled device that captures light to provide images. The captured images are then conveyed to one or more processor(s) (e.g., 130, FIG. 1) for processing, as described in connection with FIG. 1.

As shown in FIG. 4, the imaging device 410 is below the sample cartridge 420. When the sample cartridge 420 contains a biological sample in a diluent, gravity causes constituents in the biological sample to settle in the sample cartridge 420 over time. Imaging the sample cartridge 420 from below allows the settling dynamics of various constituents to be used in evaluating the biological sample. For example, in certain diluents, WBCs settle at a rate greater than 1.0 micrometers per second, RBCs settle at a rate of about 1 micrometer per second, and platelets settle at a rate of about 0.3 micrometers per second. In the embodiment of FIG. 4, the sample cartridge 420 has a translucent or transparent bottom through which the image device 410 may capture images of fields of view containing at least a portion of the sample cartridge 420. The relative settling rates of the cells allow RBCs and WBCs, which settle quicker, to separate to some degree from platelets in the sample cartridge over time and allow the imaging device 410 to capture images of platelets more clearly due to the separation.

FIG. 5 shows a bottom perspective view of an example of portions of a sample cartridge. The sample cartridge includes a sample chamber top portion 522 and a sample chamber bottom portion 524. The sample chamber top and bottom portions 522, 524 combine together to form a sample chamber between them, with an inlet port 526. The bottom sample chamber portion 524 has a translucent or transparent bottom through which an imaging device can image the sample chamber. In embodiments, the bottom sample chamber portion 524 is made of glass. In embodiments, the bottom sample chamber portion 524 can be made of polymers as long as they are optically clear, are flat, and do not auto fluoresce. The sample cartridge may have any suitable shape and dimensions for interoperability with an imaging device and/or with a point-of-care apparatus. The sample chamber formed by the top and bottom portions 522, 524 may have any suitable shape and dimensions for holding a biological sample and other materials, such as reagents and/or diluents, among other possible materials.

In embodiments, the sample chamber is configured to have a sufficient depth dimension to allow constituents in the sample to separate to some degree as they settle in the sample chamber. In embodiments, the sample chamber has a single depth dimension throughout the sample chamber. In embodiments, the sample chamber has two or more regions that have different depth dimensions. For example, as illustrated, the sample chamber may include a flat bottom portion 524 and a molded top portion 522 that create the regions with different depth dimensions. In embodiments, the sample chamber can include, for example, a region with a depth dimension of one-hundred (100) micrometers and a region with a depth dimension of three-hundred (300) micrometers. In embodiments, the sample chamber can include, for example, a region with a depth dimension of one-hundred (100) micrometers, a region with a depth dimension of two-hundred (200) micrometers, and/or a region with a depth dimension of four-hundred (400) micrometers. Sample chambers having regions with other depth dimensions and/or with other combinations of depth dimensions are contemplated to be within the scope of the present disclosure.

As mentioned above, in embodiments, an entire cross-sectional area of the sample chamber corresponds to more than one-hundred fields of view, such as in the range of two-hundred to four-hundred fields of view, among other possibilities. In embodiments, the entire cross-sectional area of the sample chamber in the sample cartridge corresponds to less than one-hundred fields of view.

Accordingly, various aspects of components of the present disclosure have been described with respect to FIGS. 1-5. As described above, aspects of the present disclosure evaluate constituents in the same analysis in order to reduce a clinician's workflow, reagent management, and run costs. In embodiments, the biological sample is a whole blood sample that is collected in EDTA (ethylenediaminetetraacetic acid) anticoagulant and is mixed with reagents which dilute the sample, maintain the morphologic properties of the sample, and stain cells containing nucleic acids. In embodiments, the biological sample is ear cerumen, peripheral blood, a fine needle aspirate, lavage fluids, body cavity fluids, semen, saliva, skin swabs, skin scrapes, fecal matter, or urine, and is mixed with a diluent. In blood samples, platelets may be a constituent of interest that settles slowly. In ear cerumen and fine needle aspirate samples, bacteria may be a constituent of interest that settles slowly or does not settle. Other biological samples and collection techniques, reagents, and/or stains are contemplated to be within the scope of the present disclosure.

The following will describe techniques for imaging and quantifying a constituent of interest in a biological sample. As described below, the techniques involve counting one or more constituents in a column of a sample chamber, determining a depth distribution of the constituent(s) across various depths of the column, and quantifying a constituent of interest based on the depth distribution and based on one or more depth distribution curves. As described below, a depth distribution curve encompasses two different types of curves—a curve that is fitted to a depth distribution or a reference curve. These aspects are described in detail below.

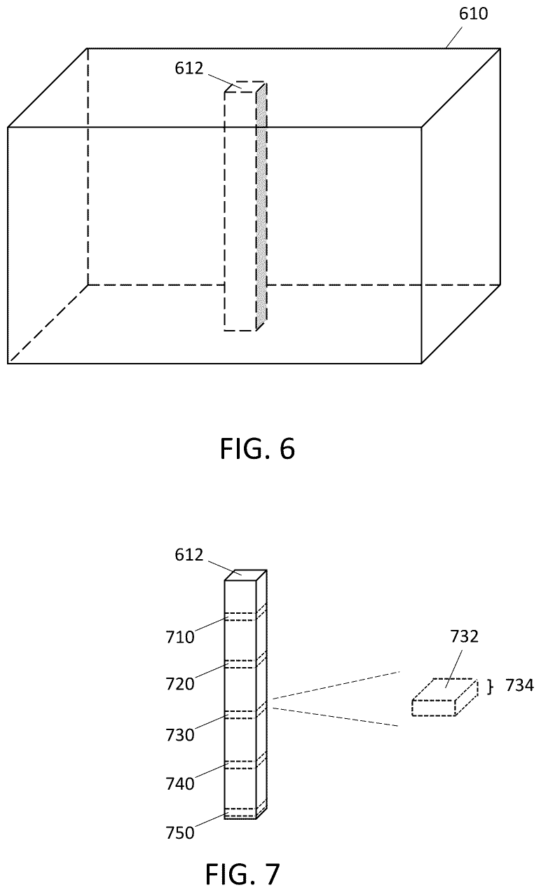

FIG. 6 shows a diagram of an example of a sample chamber 610. The shape and relative dimensions are merely illustrative, and other shapes and relative dimensions are contemplated. As mentioned above, an entire cross-sectional area of the sample chamber 610 may correspond to less than one-hundred fields of view or may correspond to more than one-hundred fields of view.

In the sample chamber 610 FIG. 6, the column 612 corresponds to a single field of view. A field of view containing a portion of a sample chamber may be captured using any working distance and depth of field. As mentioned above in connection with FIG. 4, each image captures a field of view. Working distance refers to the object to lens distance where the image is at its sharpest focus, and depth of field reflects the distance between the nearest and furthest elements in a captured image that appear to be acceptably in focus. For example, if a sample chamber depth dimension is one-hundred micrometers and the working distance is within the sample chamber, then a depth of field of ten micrometers would result in some depths within the sample chamber not being in acceptable focus in the field of view. In such cases, the lens of the imaging device would need to be moved in the depth direction (e.g., Z-direction) to bring other portions of the depth within the sample chamber into acceptable focus.

An imaging device and/or a sample cartridge may move at a rate such that between fifty to one-hundred different fields of view are captured each minute. Other rates of capturing fields of view are contemplated.

FIG. 7 is a diagram of the column 612 of FIG. 6. The sample chamber 610 of FIG. 6 is filled with a mixture of a biological sample and a diluent. For a well-mixed mixture, the biological sample will be distributed across the sample chamber 610 and the column 612. Five depth regions 710-750 in the column 612 are shown, and they correspond to depths that an imaging device will focus on to capture images. Using one depth region 730 as an example, the region has a cross-section 732 that corresponds to the field of view of the imaging device and has a depth dimension 734 that corresponds to the depth of field of the imaging device. In this configuration, when the imaging device focuses on the depth region 730 and captures an image, constituents in the depth region 730 will be in acceptable focus while constituents outside the depth region 730 will not be in acceptable focus.

In FIG. 7, the imaging device captures images of the five depth regions 710-750 in acceptable focus, which by themselves do not capture the entirety of the column 612 in acceptable focus. In accordance with aspects of the present disclosure, an imaging device is controlled to just capture portions of the entire column 612 in acceptable focus. The captured portions may be any number of contiguous or non-contiguous portions and may be more than five depth portions or less than five depth portions. Capturing more depth portions requires more time and memory for capturing and storing the images, but results in more data about the contents of the column 612. Capturing fewer depth portions takes less time and memory, but results in less data about the contents of the column 612. The number of depth portions to capture by an imaging device may be different for different applications. The number of depth portions can be determined to capture for a particular application.

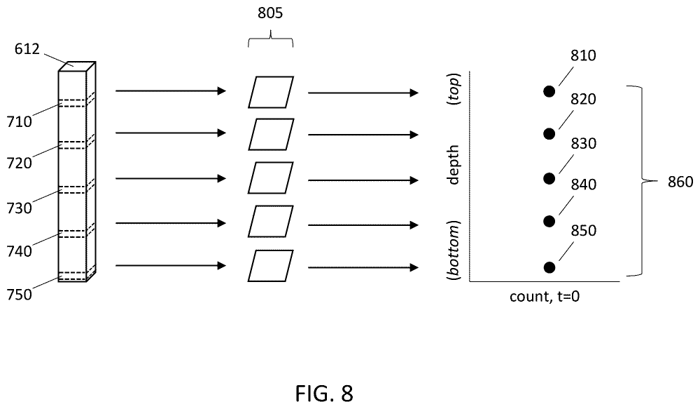

Referring to FIG. 8, and in accordance with aspects of the present disclosure, the images of the depth portions are analyzed to count one or more constituents and to determine a depth distribution. In FIG. 8, the five images 805 correspond to the images captured of the five depth regions 710-750. As long as a biological sample is sufficiently diluted, the constituents in the mixture will be dispersed enough so that an imaging device will be able to capture any depth region 710-750 without the intervening constituents occluding the view of the depth region. The proper dilution ratio can be determined for any given biological sample.

In embodiments, trained machine learning models and/or image analytics are applied to analyze the captured images 805. In embodiments, one or more machine learning models are trained for object detection to detect various constituents in the images. For example, one or more machine learning models may be trained to analyze the images to detect red blood cells, white blood cells, platelets, bacteria, debris, lipids, and/or cell clusters, among other possible objects. Such machine learning models can be implemented and trained, which may include convolutional neural networks, among other machine learning models.

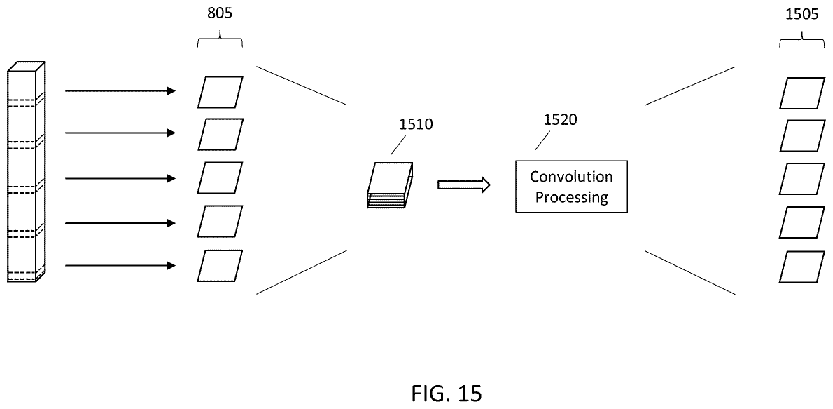

Various cases and scenarios will be described below. For now, it is sufficient to note that a single type of constituent may be detected or multiple types of constituents may be detected from the images 805. The detected constituents are counted to determine a count 810-850 for each of the depth regions 710-750. In aspects of the present disclosure, because constituent(s) of each depth portion are counted, any two adjacent depth portions should not overlap to avoid or reduce double-counting. Accordingly, the depths of any two adjacent depth portions should differ by at least the imaging device's depth of field. Further techniques for avoiding or reducing double-counting are described in connection with FIG. 15.

FIG. 8 shows a plot of the counts 810-850, where the vertical axis of the plot corresponds to depth in a column and the horizontal axis corresponds to magnitude of the count. Taken together, the counts 810-850 form a depth distribution 860 that reflects how the detected constituent(s) are distributed across the depth regions 710-750 of the column 612. For a well-mixed mixture, the constituents should initially be well-distributed through the column 612. FIG. 8 shows an example of an even depth distribution 860 across the depth regions 710-750. The plot is merely illustrative. In embodiments, the depth distribution 860 may be stored as numerical pairs, such as (depth₁, count₁), . . . , (depthₙ, countₙ). Such and other implementations are within the scope of the present disclosure.

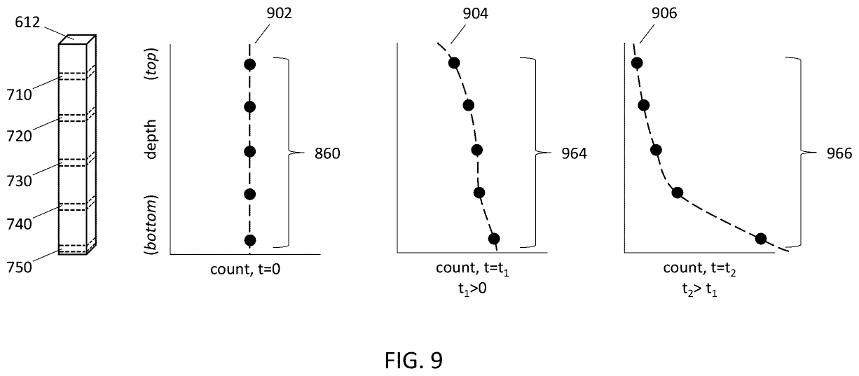

Over time, the constituents settle and the depth distribution changes, as shown in the example of FIG. 9. FIG. 9 shows three depth distributions corresponding to three different time instances, t=0, t=t₁, and t=t₂, where t₂>t₁>0. The initial depth distribution 860 at t=0 is the same as that of FIG. 8 and reflects a uniform initial distribution. As the constituents settle, the highest depth region 710 will gradually have fewer constituents, and the lowest depth region 750 will gradually have more constituents. If the constituents are settling uniformly, the depth regions in between (720-740) would not show significant changes until more time has passed. In the example of FIG. 9, at time t=t₁, the middle regions 720-740 still have similar numbers of constituents. The counts at time t=t₁ form a depth distribution 964 for time t₁. After sufficient time has passed, most of the constituents will have settled to the lower regions of the column 612, and the upper regions will have significantly less constituents. This is reflected in the counts in the depth distribution 966 at time t₂.

It should be noted that the depth distributions 860, 964, 966 are not snapshots of constituent counts at a single point in time. The images of the depth regions 710-750 are captured sequentially and involve moving the sample cartridge and/or the imaging device to focus on the individual depth regions. Accordingly, the time indicators t₁ and t₂ generally indicate different time periods. The time indicators t₁ and t₂ may, however, correspond to the time point when the first image was captured, the time point when the last image was captured, or a time point in between.

The uniform depth distribution 860 in FIG. 8 and FIG. 9 is merely illustrative of an ideal mixture. In actuality, a well-mixed mixture will most likely still exhibit variations across different depth regions. Moreover, images of the depth regions may be captured some time after the mixture is prepared. It takes time to move the sample cartridge into position to capture images (e.g., in the apparatus of FIG. 4), and because images may be captured for multiple columns, the images of some columns would be captured earlier while the images of some columns would be captured later. Accordingly, a depth distribution for a column may take on any progression. Thus, FIG. 8 and FIG. 9 are merely examples and do not limit the scope of the present disclosure.

In accordance with aspects of the present disclosure, with continuing reference to FIG. 9, a curve is fitted to a depth distribution to be used in estimating constituent count for a column. FIG. 9 shows examples of curves that are fitted to depth distributions. Specifically, curve 902 is fitted to depth distribution 860, curve 904 is fitted to depth distribution 964, and curve 906 is fitted to depth distribution 966. The fitted curves 902-906 shown in FIG. 9 are merely examples. In embodiments, a fitted curve may not traverse each point of the depth distribution. Curve fitting can be performed to derive a fitted curve.

In accordance with aspects of the present disclosure, one or more fitted curves 902-906 are used to estimate the constituent count in the column 612. While the depth regions 710-750 and the depth distributions 860, 964, 966 cover less than the entire column 612, the fitted curves 902-906 cover the entire column 912. Each fitted curve 902-906 provides an estimate of the constituent counts throughout the column 612. Accordingly, in aspects of the present disclosure, a fitted curve is used to estimate the total constituent count in the entire column 612. For example, if a fitted curve is denoted as F(y) (where y is depth in the column 612) and the column 612 has a total of i=1 . . . n contiguous depth regions (each region having the same height h, e.g., 734 of FIG. 7), then the total constituent count for the column 612 can be estimated by Σᵢ₌₁ⁿ F(i*h). As mentioned above, a fitted curve may not traverse each point of a depth distribution. However, because a fitted curve would overshoot in some depth regions and undershoot in other depth regions, the overall fitted curve evens out those differences such that use of the fitted curve across the entire depth of the column 612 provides an estimate of the total constituent count for the entire column 612.

In embodiments, the estimated total constituent count for a column can be based on one fitted curve corresponding to one time period. In embodiments, the estimated total constituent count for a column can be based on multiple fitted curves corresponding to multiple time periods, such as based on the three fitted curves 902-906 shown in FIG. 9. In the latter case, a separate total count may be estimated based on each fitted curve 902-906, and the separate total counts may be averaged to estimate the total count for the entire column 612. In embodiments, other manners of applying more than one fitted curve to estimate the total count of a column are contemplated to be within the scope of the present disclosure.

In embodiments, based on the estimated total constituent count of a single column (e.g., 612), an estimate for the total constituent count of a sample chamber (e.g., 610, FIG. 6) can be determined by multiplying the total constituent count for the single column by the number of columns in the sample chamber. This approach assumes that the sample chamber includes a well-distributed mixture.

In embodiments, a total constituent count can be estimated for each of multiple columns in a sample chamber, and the estimates for the different columns can be averaged to estimate the average constituent count per column. This average can be multiplied by the number of columns to estimate the total constituent count for the sample chamber.

In embodiments, total constituent counts for each of multiple columns can be estimated across a sample chamber, and a surface can be fitted to the estimated total constituent counts. The fitted surface can be used to estimate the total constituent count in the sample chamber in the same way that a fitted curve is used to estimate the total constituent count in a column.

In sample chambers having multiple regions with different depth dimensions, it will be understood that the approaches disclosed above herein can be applied to estimate the total constituent counts in each region and to estimate the total constituent count in the sample chamber.

Other manners of using estimated total constituent counts in columns to estimate the total constituent count in a sample chamber are contemplated to be within the scope of the present disclosure.

The technique of FIG. 8 and FIG. 9 is applicable in various scenarios. In embodiments, the technique of FIG. 8 and FIG. 9 is especially useful when a constituent of interest can be detected, e.g., by object detection using machine learning models and/or image analytics, or otherwise.

As an example, lipids settle slowly or not at all and is a constituent of interest in various analyses. Machine learning models and/or image analytics can detect lipid particles in an image. The images may include brightfield images, fluorescence images, and/or composite images. The technique of FIG. 8 and FIG. 9 can be applied to capture images of depth regions containing lipids (in one or more columns), determine one or more depth distributions of the lipids (in one or more columns at one or more time periods), derive one or more fitted curves based on the depth distribution(s), and estimate a total lipid count in the sample chamber based on the fitted curve(s).

As another example, platelets in blood samples settle slowly or do not settle and is a constituent of interest in various analyses. Blood samples contain red blood cells, white blood cells, and platelets, and those constituents can be detected by machine learning models and/or by image analytics in an image. The images may include brightfield images, fluorescence images, and/or composite images. The technique of FIG. 8 and FIG. 9 can be applied to capture images of depth regions containing platelets (in one or more columns), determine one or more depth distributions of the platelets (in one or more columns at one or more time periods), derive one or more fitted curves based on the depth distribution(s), and estimate a total platelet count in the sample chamber based on the fitted curve(s).

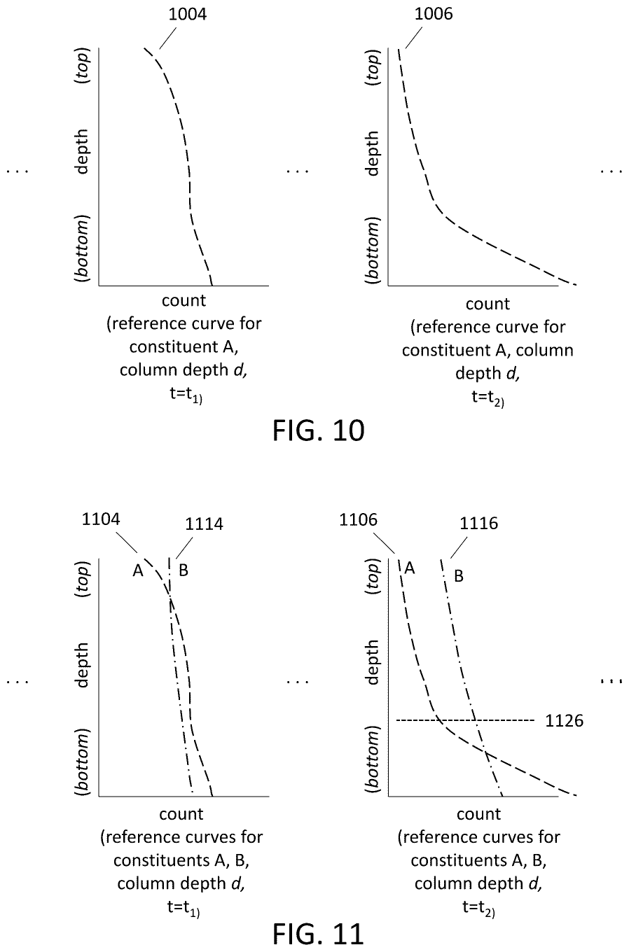

In the case of blood samples, platelets separate to some degree from RBCs and WBCs over time. As mentioned above, in certain diluents, WBCs settle at a rate greater than 1.0 micrometers per second, RBCs settle at a rate of about 1 micrometer per second, and platelets settle at a rate of about 0.3 micrometers per second. The relative settling rates of the cells allow RBCs and WBCs, which settle quicker, to separate to some degree from platelets in the sample cartridge over time. Another technique uses such separation of different constituents in counting constituents. The technique is described below in connection with FIG. 10 and FIG. 11 and involves using reference depth-distribution curves, which are reference curves that reflects settling of a constituent over time.

FIG. 10 is a diagram of examples of reference depth-distribution curves for a constituent, denoted in the example as constituent A. Constituent A may be any constituent, such as lipids, platelets, RBCs, WBCs, and/or bacteria, among others. The reference curve 1004 characterizes the depth distribution of constituent A, in an entire column of depth dimension d, at a time t₁. The reference curve 1006 characterizes the depth distribution of constituent A, in the entire column of the same depth dimension, at a different time t₂. The depth dimension may be any dimension, such as 100-micrometers, 200-micrometers, 400-micrometers, or another value. In embodiments, the times t₁ and t₂ may correspond to times after a mixture is prepared in a sample cartridge. In embodiments, the times t₁ and t₂ may be referenced to another event. The difference in the shapes of the two reference curves 1004, 1006 at times t₁ and t₂ reflects settling of constituent A between times t₁ and t₂.

In embodiments, the reference curves 1004, 1006 can be generated in controlled experiments by laboratory technicians. The controlled experiments may involve other parameters, such as diluent type and dilution ratio, among other parameters. In embodiments, each reference curve can be derived from data from multiple experiments.

The example of FIG. 10 is merely illustrative. Reference curves may be generated for any combination of constituent type, column depth dimension, time period, and/or any other parameter. The generated references curves can be stored in a database or an electronic storage to be used during a sample analysis. The reference curves may be stored in any manner. In embodiments, the reference curves may be specified by a polynomial, and the degree and coefficients of the polynomial may be stored. In embodiments, the reference curves may be stored as a set of data points (depthᵢ, countᵢ). Other manners of storing a reference curve are contemplated to be within the scope of the present disclosure.

FIG. 11 shows examples of reference curves for two different constituents, in a column of depth dimension d, at different times t₁ and t₂. At time t₁, the reference curve 1104 for constituent A and the reference curve 1114 for constituent B are similar, indicating that the two constituents have not meaningfully separated as of time t₁. At time t₂, the reference curve 1106 for constituent A and the reference curve 1116 for constituent B have diverged in the upper portions, indicating that the two constituents have substantially separated to some degree as of time t₂.

The separation depth 1126 at time t₂ is indicated by the horizontal dashed line. The separation depth 1126 may be determined in various ways and may be based on one or more separation criteria. The separation criteria may include, for example, a maximum constituent count at a particular depth level for a faster settling constituent, a minimum constituent count at a particular depth for a slower settling constituent, and/or a difference in counts for the faster and slower settling constituents, among other possible criteria. Accordingly, in aspects of the present disclosure, reference curves are used to determine a separation distance between constituents.

The example of FIG. 11 is merely illustrative. Reference curves may be accessed for any combination of constituent type, column depth dimension, time period, and/or any other parameters. The references curves may be accessed from a database or an electronic storage.

In accordance with aspects of the present disclosure, reference curves are used to determine a separation distance and are used in estimating a constituent count in a column. Continuing with the example of FIG. 11, constituent A is a faster settling constituent, and constituent B is a slowly settling constituent and is the constituent of interest.

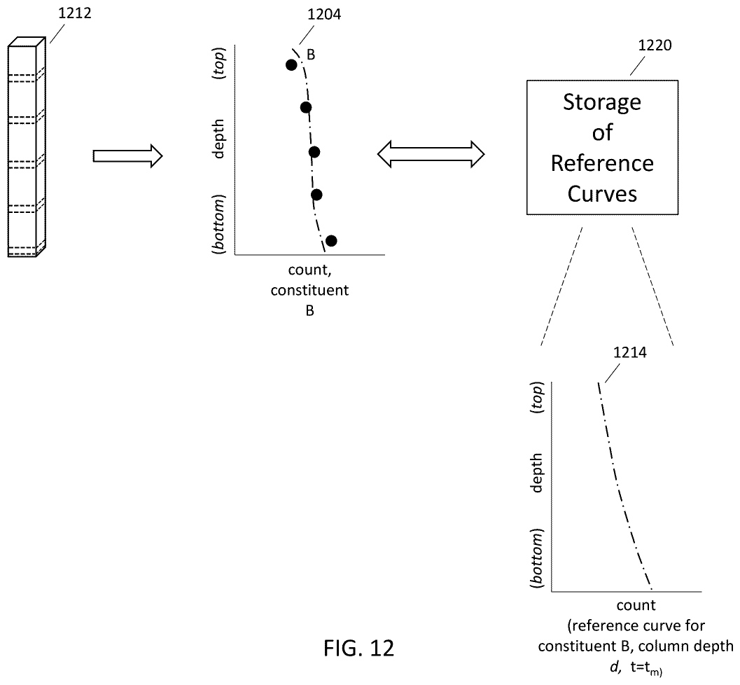

In accordance with aspects of the present disclosure, and with reference to FIG. 12, a depth distribution is determined for constituent B in a column 1212, and a fitted curve 1204 for the depth distribution is derived. The fitted curve 1204 is compared to reference curves (for constituent B in a column of same or similar depth, across a plurality of time period) stored in a storage 1220 of reference curves. Because the timing of the fitted curve 1204 may not match the timing of the reference curves in the storage 1220, the fitted curve 1204 and the reference curves in the storage 1220 can be compared based on their shapes and/or values rather than by their timing. Such comparisons can be made, including, for example, determining whether two curves have a consistent distance between them, among other techniques. Based on the comparison, it is assumed that the fitted curve 1204 most closely matches the reference curve 1214 in the storage 1220. In embodiments, rather than comparing the fitted curve 1204 to reference curves, the depth distribution can be compared to reference curves, instead. In embodiments, comparing the fitted curve 1204 to reference curves inherently compares the depth distribution to the reference curves.

In embodiments, the approach of FIG. 12 can be applied for constituent A, as well, to identify a reference curve for constituent A. In embodiments, a reference curve for constituent A may be identified based on the time of the reference curve for constituent B. For example, the reference curve 1214 of constituent B has a time of tₘ, so a reference curve for constituent A corresponding to time tₘ may be selected from the storage 1220. Then, by comparing the reference curves for constituents A and B, a separation depth may be determined in the manner described in connection with FIG. 11.

In accordance with aspects of the present disclosure, and with continuing reference to FIG. 12, the total constituent B count in the column 1212 can be estimated based on both the fitted curve 1204 and the reference curve 1214 and based on a separation depth. In embodiments, the constituent B count in the column 1212 above the separation depth is estimated using a portion of the fitted curve 1204 above the separation depth, and the constituent B count in the column 1212 below the separation depth is estimated using a portion of the reference curve 1214 below the separation depth. Then, the estimated total constituent B count in the entire column 1212 is determined by adding the two separate estimates.

For example, assume a fitted curve is denoted as F(y) and a reference curve is denoted as G(y) (where y is depth in the column 1212), the column 1212 has a total of i=1 . . . n contiguous depth regions (each region having the same height h, e.g., 734 of FIG. 7), and the separation depth occurs at depth region k. The total constituent count for the column 1212 can be estimated by Σᵢ₌₁^{k} F(i*h)+Σⱼ₌ₖ₊₁ⁿ G(j*h). This example is merely illustrative of using a fitted curve and a reference curve to estimate a total constituent count in a column. Other ways of using a fitted curve and a reference curve to estimate a total constituent count in a column and/or to estimate a total constituent count in a sample chamber are contemplated to be within the scope of the present disclosure.

The technique of FIG. 11 and FIG. 12 are useful in various scenarios. For example, in the case of a blood sample containing red blood cells, white blood cells, and platelets, platelets may be a slower settling constituent of interest, and the RBCs and WBCs are other faster settling constituents. Images of depth regions in a column can be captured, and machine learning models and/or image analytics can detect the constituents in the images. The images may include brightfield images, fluorescence images, and/or composite images. The technique of FIG. 11 and FIG. 12 can be applied to determine depth distributions and fitted curves for RBCs, WBCs, and platelets, determine reference curves that most closely match the fitted curves, determine a separation depth based on the reference curves, estimate platelet count in the column above the separation depth based on the fitted curve for the platelets, estimate platelet count in the column below the separation depth based on the reference curve for the platelets, and estimate the total platelet count in the column based on the two separate estimates. The estimated count for a column can then be used in estimating the total count in a sample chamber, in the manner described above.

The technique of FIG. 11 and FIG. 12 applies in other scenarios, as well, and variations are contemplated. For example, in embodiments, reference curves for three or more constituents can be used to determine a separation depth. Such and other variations are contemplated to be within the scope of the present disclosure

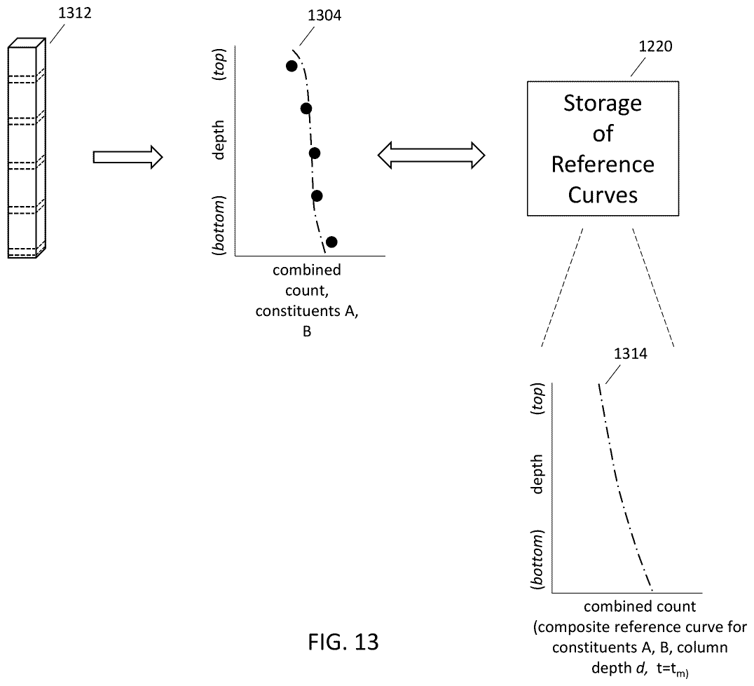

FIG. 13 shows a variation of the technique of FIG. 11 and FIG. 12. The technique of FIG. 13 is useful in situations where machine learning models and image analytics may not easily distinguish a constituent of interest from another constituent in a biological sample. For example, in ear cerumen samples, bacteria and debris may be about the same size and may appear very similar to an object detector.

In accordance with aspects of the present disclosure, two or more constituents in images are counted together, and a depth distribution and fitted curve are derived for the combined count. In the example of FIG. 13, constituents A and constituent B in the column 1312 are counted together to derive the depth distribution and the fitted curve 1304. The storage 1220 contains reference curves for constituent A and reference curves for constituent B for a plurality of parameters and time periods. Such reference curves can be combined to form composite reference curves, and the composite reference curves are compared to the fitted curve 1304. The composite reference curve 1314 that most closely matches the fitted curve 1304 is selected along with the underlying reference curve for constituent A and the reference curve for constituent B. In embodiments, the storage 1220 can store composite curves. In embodiments, the storage 1220 may not store composite curves, and composite curves may be generated as needed. In embodiments, rather than comparing the fitted curve 1304 to reference curves, the depth distribution can be compared to reference curves, instead. In embodiments, comparing the fitted curve 1304 to reference curves inherently compares the depth distribution to the reference curves.

In embodiments, the underlying reference curve for the constituent of interest—either constituent A or constituent B—can be used to determine an estimate for constituent count in the column 1312, in the manner described in connection with FIG. 9. In embodiments, the underlying reference curves for constituent A and constituent B can be used to determine a separation depth in the manner described in connection with FIG. 11, and the fitted curve 1304 above the separation depth and a reference curve below the separation depth can be used to estimate total constituent count in the column 1312. FIG. 13 is merely an example, and the technique of FIG. 13 is applicable to scenarios where three or more constituents are counted together, as well.

Applying the technique of FIG. 13 to an ear cerumen sample, the constituent of interest in the sample is bacteria, and other constituents include debris. Images of depth regions in a column can be captured, and machine learning models and/or image analytics can detect the constituents in the images. The images may include brightfield images, fluorescence images, and/or composite images. The technique of FIG. 13 can be applied to determine a combined depth distribution and fitted curve for bacteria and debris, determine a composite reference curve that most closely matches the fitted curve, access the reference curve for bacteria underlying the composite reference curve, and estimate bacteria count in the column based on reference curve for bacteria. In embodiments, the underlying reference curves for bacteria and debris can be used to determine a separation depth, and the fitted curve above the separation depth and the reference curve for bacteria below the separation depth can be used to estimate total bacteria count in the column. The estimated count for a column can then be used in estimating the total count in a sample chamber, in the manner described above.

Accordingly, various techniques for quantifying constituents have been described in connection with FIGS. 6-13.

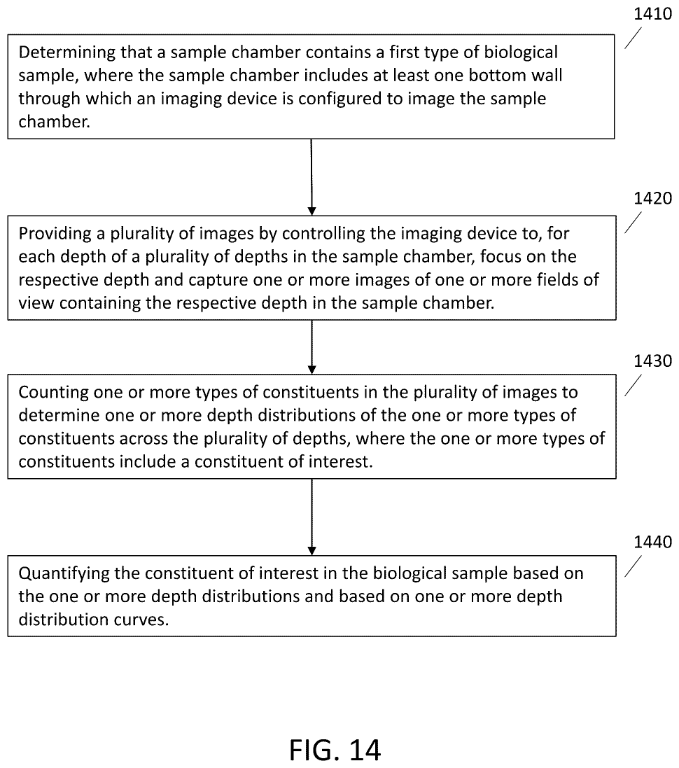

FIG. 14 is a flow diagram of an operation for analyzing a biological sample. At block 1410, the operation involves determining that a sample chamber contains a first type of biological sample, where the sample chamber includes at least one bottom wall through which an imaging device is configured to image the sample chamber. The contents of the sample chamber may be determined in various ways. In embodiments, the contents of the sample chamber may be determined by scanning a code on a sample cartridge, such as scanning a barcode or an alphanumeric code, among other possible codes. The scanner for scanning the code may be fixed within a point-of-care apparatus or may be a separate device, such as a camera of a smartphone, which can communicate a result of the scan to a point-of-care apparatus. In embodiments, a user of a point-of-care apparatus may manually indicate the contents of the sample chamber, e.g., by selecting an option on a user interface. Such and other embodiments are contemplated to be within the scope of the present disclosure.

At block 1420, the operation involves providing a plurality of images by controlling the imaging device to, for each depth of a plurality of depths in the sample chamber, focus on the respective depth and capture one or more images of one or more fields of view containing the respective depth in the sample chamber. The operation of block 1420 corresponds to the operation described in connection with FIG. 8 for a single column or the operation described in connection with FIG. 9 (e.g., images at different time periods). The operation of block 1420 also covers an operation that captures images of a plurality of depths in multiple different columns.

At block 1430, the operation involves counting one or more types of constituents in the plurality of images to determine one or more depth distributions of the one or more types of constituents across the plurality of depths, where the one or more types of constituents include a constituent of interest. The operation of block 1430 covers the operations described in connection with FIG. 8, FIG. 12, and FIG. 13. For example, the operation of block 1430 covers determining a depth distribution for a single constituent (e.g., FIG. 12) or determining a composite depth distribution for multiple constituents (e.g., FIG. 13). The operation of block 1430 covers determining a depth distribution for a single column or determining depth distributions for multiple columns. The operation of block 1430 covers determining a depth distribution for a single time period or determining depth distributions for multiple time periods.

At block 1440, the operation involves quantifying the constituent of interest in the biological sample based on the one or more depth distributions and based on one or more depth distribution curves. The operation of block 1440 covers the operations described in connection with FIG. 8, FIG. 12, and FIG. 13. Thus, the depth distribution curves of block 1440 may be fitted depth distribution curves and/or reference depth distribution curves. The operation of block 1440 covers quantifying a constituent of interest based on the one or more depth distributions and based on one or more fitted curves. The operation of block 1440 covers quantifying a constituent of interest based on the one or more depth distributions and based on one or more reference curves. Because a depth distribution is used to derive a fitted curve, and a depth distribution or a fitted curve is used to find a closest matching reference curve, the process of quantifying the constituent of interest is based on the depth distribution(s). In embodiments, quantifying the constituent of interest may involve providing a constituent count in a column of a sample chamber or providing a constituent count in a sample chamber. In embodiments, quantifying the constituent of interest may involve finding one instance of a constituent of interest (e.g., bacteria).

FIG. 14 is merely illustrative, and variations are contemplated to be within the scope of the present disclosure. In embodiments, an operation may include other blocks not shown in FIG. 14. In embodiments, an operation may not include every block shown in FIG. 14. In embodiments, an operation may include the blocks of FIG. 14 in a different order. Such and other embodiments are contemplated to be within the scope of the present disclosure.

As an example of a variation, an operation may include, in place of or in addition to the blocks of FIG. 14, the following functionality. In embodiments, a method for imaging a biological sample includes: receiving a sample cartridge defining a sample chamber; determining whether a biological sample within the sample chamber is a first fluid type; in response to determining that the biological sample is the first fluid type, performing a first operation; and in response to determining that the biological sample within the sample chamber is not the first fluid type, performing a second operation. The first operation includes: imaging first constituents of the biological sample at a first depth within the sample chamber; and imaging second constituents of the biological sample at a second depth within the sample chamber, where the second depth is different than the first depth. The second operation includes: imaging first constituents of the biological sample at a first depth within the sample chamber; and imaging second constituents of the biological sample at a third depth within the sample chamber, where the third depth is different than the first depth and the second depth. Such embodiments are contemplated to be within the scope of the present disclosure.

As mentioned above, FIG. 15 relates to a technique for avoiding or reducing double-counting or multiple counts of the same instance of a constituent in different images. Even when adjacent depth portions (e.g., 710-750, FIG. 8) do not overlap and their depths differ by at least the imaging device's depth of field, portions of the field of view outside a specific depth portion would still be visible in the image but would be out of focus.

In accordance with aspects of the present disclosure, and with reference to FIG. 15, the captured images 805 are stacked to form a three-dimensional (3D) pixel array 1510. The 3D pixel array 1510 is processed by convolution processing 1520. The convolution processing 1520 operates overall to perform sharpening in each image of the stack and to perform gradient/edge detection in the depth direction and will be described in more detail below. After the convolution processing 1520, the individual images can be separated from the pixel array into individual images 1505 of the depth regions again.

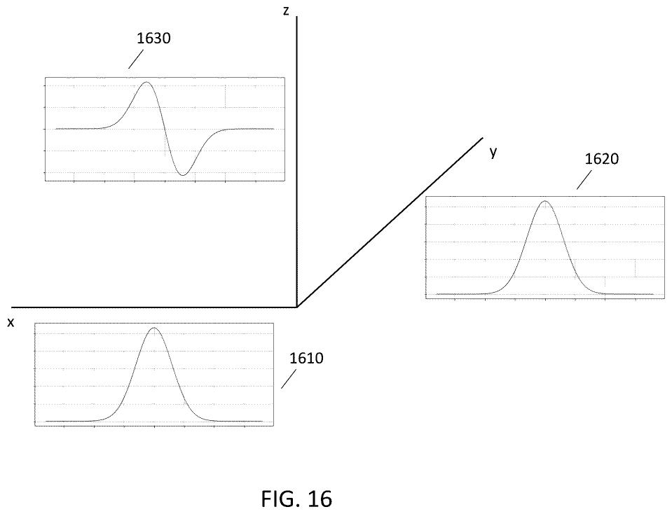

In accordance with aspects of the present disclosure, rather than performing a three-dimensional convolution, multiple one-dimensional convolutions are performed. FIG. 16 shows an example of three one-dimensional convolution kernels, including a one-dimensional kernel 1610 in the x-direction, a one-dimensional kernel 1620 in the y-direction, and a one-dimensional kernel 1630 in the z-direction. A convolution kernel is a set of coefficients used to compute a weighted sum. In the illustration, the kernels 1610, 1620 in the x-direction and the y-direction are Gaussian kernels which perform a degree of sharpening in the x-direction and the y-direction. The kernel 1630 in the z-direction is a derivation of Gaussian kernel, which performs a degree of gradient/edge detection in the z-direction. The illustrated kernels are merely examples, and other kernels that perform sharpening or gradient/edge detection, or that perform other processing, are contemplated to be within the scope of the present disclosure.

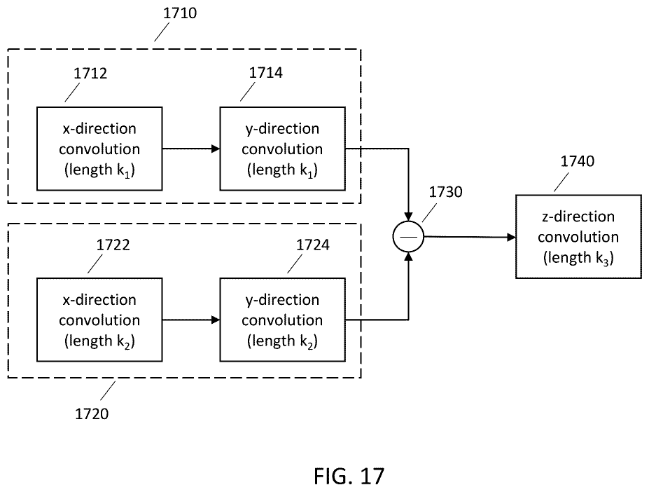

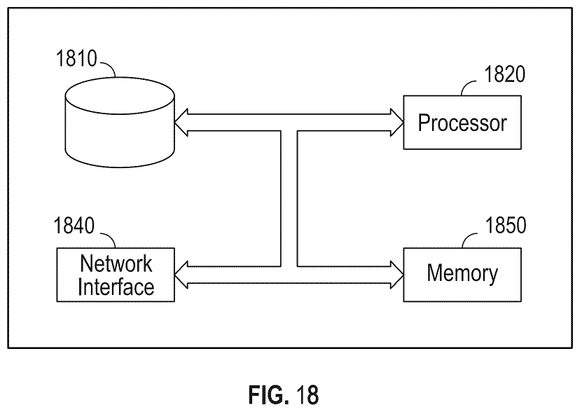

In accordance with aspects of the present disclosure, and with reference to FIG. 17, the convolution processing involves applying a narrower convolutional operation 1710, with kernel length k₁, and a wider convolutional operation 1720, with kernel length k₂, where k₂>k₁. The narrower convolutional operation 1710 is performed using one x-direction convolution (length k₁) 1712 and one y-direction convolution (length k₁) 1714. The wider convolutional operation 1720 is performed using one x-direction convolution (length k₂) 1722 and one y-direction convolution (length k₂) 1724. A difference operation 1730 is performed between the results of the narrower convolutional operation 1710 and the wider convolutional operation 1720. The result of the difference operation 1730 is processed by z-direction convolution 1740, with kernel length k₃, where kernel length k₃ may be any value. The convolutions in the narrower convolutional operation 1710 and in the wider convolutional operation 1720 can use Gaussian kernel, and the z-direction convolution 1740 can be a derivative of Gaussian kernel, such as those shown in FIG. 16. In embodiments, the convolutions shown in FIG. 17 can be other types of kernel or convolutions.

Referring also to FIG. 15, the 3D pixel array 1510 is processed by the narrower convolutional operation 1710 to provide a first modified 3D pixel array and is processed by the wider convolutional operation 1720 to provide a second modified 3D pixel array. The difference operation 1730 provides a third modified 3D pixel array as a difference between the first modified 3D pixel array and second modified 3D pixel array. The third modified 3D pixel array is processed by the z-direction convolution 1740 to provide a fourth modified 3D pixel array. In the fourth modified 3D pixel array, the processing can identify peaks above a threshold, which should correspond to the locations of the objects, and determine the (x,y,z) locations of the peaks/objects. The various locations (x,y,z) of objects can be aggregated according to depth regions and can be counted as described above herein. In embodiments, the fourth modified 3D pixel array can be separated into the images 1505 of FIG. 15.

By appropriately sizing the convolution lengths and the sigma values of the Gaussian kernels and of the derivative of Gaussian kernel, the operation of FIG. 17 effectively looks for salient spots roughly of a certain size (k₁), relative to background intensity sampled over a region of size k₂, that transition from darker to brighter over a distance k₃ in the z-direction. In embodiments, the sigma value (i.e., standard deviation value) of the Gaussian kernels of the narrower convolutional operation 1710 is equivalent to about 1.8 pixels, the sigma value of the Gaussian kernels of the wider convolutional operation 1720 is equivalent to about 3.6 pixels, and the sigma value of the derivative of Gaussian kernel of the z-direction convolution 1740 is equivalent to about 2 pixels. Such sigma values are merely examples, and other sigma values and other kernel values are contemplated to be within the scope of the present disclosure.

In embodiments, the coefficients of each of the one-dimensional convolutions can be computed using closed-form definitions for the Gaussian and its derivative, such that the only free parameters of a convolution are the sigma values. Benefits of using parameterized separable convolutions include, for example, constraining model parameters and reducing possibility of overfitting, providing rotational invariance in x-direction and y-direction as well as invariance to image background brightness, reducing high computational demand of 3D convolution, and using human-interpretable parameters, among other benefits.

Referring now to FIG. 18, there is shown a block diagram of example components of a point-of-care apparatus at a veterinary facility. The point-of-care apparatus includes an electronic storage 1810, a processor 1820, a network interface 1840, and a memory 1850. The various components may be communicatively coupled with each other. The processor 1820 may be and may include any type of processor, such as a single-core central processing unit (CPU), a multi-core CPU, a microprocessor, a digital signal processor (DSP), a System-on-Chip (SoC), or any other type of processor. The memory 1850 may be a volatile type of memory, e.g., RAM, or a non-volatile type of memory, e.g., NAND flash memory. The memory 1850 includes processor-readable instructions that are executable by the processor 1820 to cause the apparatus to perform various operations, including those mentioned herein, such as the operations shown and described in connection with FIGS. 8-17, and/or applying machine learning models or image analytics, among others.

The electronic storage 1810 may be and include any type of electronic storage used for storing data, such as hard disk drive, solid state drive, and/or optical disc, among other types of electronic storage. The electronic storage 1810 stores processor-readable instructions for causing the apparatus to perform its operations and stores data associated with such operations, such as storing data relating to computations and storing captured images, among other data. The network interface 1840 may implement wireless networking technologies and/or wired networking technologies.

The components shown in FIG. 18 are merely examples, and it will be understood that a coordination system includes other components not illustrated and may include multiples of any of the illustrated components. Such and other embodiments are contemplated to be within the scope of the present disclosure.

The above-described embodiments can be expressed in the following numbered aspects:
Aspect A1. An apparatus for analyzing a biological sample, the apparatus comprising: at least one processor; and
at least one memory storing instructions which, when executed by the at least one processor, cause the apparatus at least to perform:
   determining that a sample chamber contains a first type of biological sample, the sample chamber comprising at least one bottom wall through which an imaging device is configured to image the sample chamber;
   providing a plurality of images by controlling the imaging device to, for each depth of a plurality of depths in the sample chamber:
      focus on the respective depth, and
      capture one or more images of one or more fields of view containing the respective depth in the sample chamber;
   counting one or more types of constituents in the plurality of images to determine one or more depth distributions of the one or more types of constituents across the plurality of depths, the one or more types of constituents comprising a constituent of interest; and
   quantifying the constituent of interest in the biological sample based on the one or more depth distributions and based on one or more depth distribution curves.
Aspect A2. The apparatus of Aspect A1,
wherein the one or more depth distributions cover less than an entire column of the sample chamber, and
wherein the one or more depth distribution curves cover the entire column of the sample chamber.
Aspect A3. The apparatus of Aspect A1 or Aspect A2,
wherein the one or more depth distributions comprise a depth distribution of the constituent of interest, and
wherein the one or more depth distribution curves comprise a fitted curve fitted to the depth distribution of the constituent of interest.
Aspect A4. The apparatus of Aspect A3,
wherein in the quantifying the constituent of interest in the biological sample, the instructions, when executed by the at least one processor, cause the apparatus at least to perform:
estimating, based on the fitted curve, a count of the constituent of interest in the entire column of the sample chamber; and
estimating, based on the count of the constituent of interest in the entire column of the sample chamber, a total count of the constituent of interest in the sample chamber.
Aspect A5. The apparatus of Aspect A1 or Aspect A2,
wherein the one or more depth distributions comprise a plurality of depth distributions of the constituent of interest, each of the plurality of depth distributions corresponding to a different time period,
wherein the one or more depth distribution curves comprise a plurality of fitted curves, each of the plurality of fitted curves being fitted to a corresponding one of the plurality of depth distributions of the constituent of interest.
Aspect A6. The apparatus of Aspect A5, wherein in the quantifying the constituent of interest in the biological sample, the instructions, when executed by the at least one processor, cause the apparatus at least to perform:
for each fitted curve of the plurality of fitted curves, estimating, based on the respective fitted curve, a respective count of the constituent of interest in the entire column of the sample chamber;
providing an average of the respective counts as an estimated count of the constituent of interest in the entire column of the sample chamber; and
estimating, based on the average of the respective counts, a total count of the constituent of interest in the sample chamber.
Aspect A7. The apparatus of Aspect A2,
wherein the one or more types of constituents further comprise at least one second constituent which settles faster than the constituent of interest,
wherein the one or more depth distributions comprise a depth distribution of the constituent of interest, and
wherein the instructions, when executed by the at least one processor, further cause the apparatus at least to perform:
   determining a separation depth above which the constituent of interest is substantially separated from the second constituent, wherein the determining is based on at least one separation criterion.
Aspect A8. The apparatus of Aspect A7, wherein the instructions, when executed by the at least one processor, further cause the apparatus at least to perform:
estimating a count of the constituent of interest above the separation depth in the entire column of the sample chamber based on a portion of the first depth distribution above the separation depth;
identifying a reference depth-distribution curve for the constituent of interest corresponding to the first depth distribution, wherein the one or more depth distribution curves comprises the reference depth-distribution curve; and
estimating a count of the constituent of interest below the separation depth in the entire column of the sample chamber based on a portion of the reference depth-distribution curve below the separation depth.
Aspect A9. The apparatus of Aspect A8, wherein in the quantifying the constituent of interest in the biological sample, the instructions, when executed by the at least one processor, cause the apparatus at least to perform:
estimating a total count of the constituent of interest in the entire column of the sample chamber as a sum of:
   the estimated count of the constituent of interest above the separation depth in the entire column of the sample chamber, and
   the estimated count of the constituent of interest below the separation depth in the entire column of the sample chamber.
Aspect A10. The apparatus of Aspect A8 or Aspect A9, wherein in the identifying the reference depth-distribution curve for the constituent of interest corresponding to the first depth distribution, the instructions, when executed by the at least one processor, cause the apparatus at least to perform:
comparing the first depth distribution of the constituent of interest to a plurality of reference depth-distribution curves, each of the plurality of reference depth-distribution curves corresponding to a different time period; and
based on the comparing, selecting a closest match among the plurality of reference depth-distribution curves as the reference depth-distribution curve for the constituent of interest corresponding to the first depth distribution.
Aspect A11. The apparatus of Aspect A10, wherein the instructions, when executed by the at least one processor, further cause the apparatus at least to perform:
identifying a reference depth-distribution curve for the second constituent corresponding to the reference depth-distribution curve for the constituent of interest.
Aspect A12. The apparatus of Aspect A11, wherein in the determining the separation depth, the instructions, when executed by the at least one processor, cause the apparatus at least to perform:
applying the at least one separation criterion to the reference depth-distribution curve for the constituent of interest and the reference depth-distribution curve for the second constituent to determine a depth at which the least one separation criterion is satisfied; and
providing the depth at which the least one separation criterion is satisfied as the separation depth.
Aspect A13. The apparatus of any one of Aspect A7 to Aspect A12, wherein the instructions, when executed by the at least one processor, further cause the apparatus at least to perform:
detecting, in the plurality of images, at least the constituent of interest and the second constituent by performing object detection on the plurality of images.
Aspect A14. The apparatus of Aspect A2,
wherein the one or more types of constituents further comprise at least one other constituent,
wherein the one or more depth distributions comprise a composite depth distribution of the constituent of interest and the at least one other constituent, and
wherein the instructions, when executed by the at least one processor, further cause the apparatus at least to perform:
   identifying a composite reference depth-distribution curve for the constituent of interest and the at least one other constituent, the composite reference depth-distribution curve corresponding to the composite depth distribution, wherein the one or more depth distribution curves comprise the composite reference depth-distribution curve.
Aspect A15. The apparatus of Aspect A14, wherein in the identifying the composite reference depth-distribution curve for the constituent of interest and the at least one other constituent, the instructions, when executed by the at least one processor, cause the apparatus at least to perform:
comparing the composite depth distribution to a plurality of composite reference depth-distribution curves, each of the plurality of composite reference depth-distribution curves corresponding to a different time period; and
based on the comparing, selecting a closest match among the plurality of composite reference depth-distribution curves as the composite reference depth-distribution curve for the constituent of interest and the at least one other constituent.
Aspect A16. The apparatus of Aspect A14 or Aspect A15, wherein the instructions, when executed by the at least one processor, further cause the apparatus at least to perform:
determining a separation depth above which the constituent of interest is substantially separated from the at least one other constituent, wherein the determining is based on the composite reference depth-distribution curve.
Aspect A17. The apparatus of Aspect A16, wherein the instructions, when executed by the at least one processor, further cause the apparatus at least to perform:
estimating a count of the constituent of interest above the separation depth in the entire column of the sample chamber; and
estimating a count of the constituent of interest below the separation depth in the entire column of the sample chamber based on a portion of a reference depth-distribution curve below the separation depth, the reference depth-distribution curve corresponding to the constituent of interest and being associated with the composite reference depth-distribution curve.
Aspect A18. The apparatus of Aspect A1, wherein in the quantifying the constituent of interest in the biological sample, the instructions, when executed by the at least one processor, cause the apparatus at least to perform:
determining that at least one instance of the constituent of interest is in the plurality of images.
Aspect A19. The apparatus of any of the preceding Aspect As, wherein in providing the plurality of images, the instructions, when executed by the at least one processor, cause the apparatus at least to perform:
forming a three-dimensional pixel array based on at least some of the one or more images of the one or more fields of view containing the respective depths of the plurality of depths,
wherein the three-dimensional pixel array comprises a first dimension, a second dimension, and a third dimension.
Aspect A20. The apparatus of Aspect A19, wherein in providing the plurality of images, the instructions, when executed by the at least one processor, cause the apparatus at least to perform:
applying, for at least a portion of the three-dimensional pixel array, at least one one-dimensional convolution in the first dimension, at least one one-dimensional convolution in the second dimension, and at least one one-dimensional convolution in the third dimension.
Aspect A21. The apparatus of Aspect A19, wherein in providing the plurality of images, the instructions, when executed by the at least one processor, cause the apparatus at least to perform:
applying, for at least a portion of the three-dimensional pixel array, a narrower convolutional operation in the first dimension and the second dimension, a wider convolutional operation in the first dimension and the second dimension, and at least one one-dimensional convolution in the third dimension.
Aspect A22. The apparatus of Aspect A21, wherein the narrower convolutional operation comprises a first convolution in the first dimension and a second convolution in the second dimension,
wherein the wider convolutional operation comprises a third convolution in the first dimension and a fourth convolution in the second dimension, and
wherein kernels of the first convolution and the second convolution are smaller than kernels of the third convolution and the fourth convolution.
Aspect A23. The apparatus of Aspect A21 of Aspect A22, wherein in the applying, the instructions, when executed by the at least one processor, cause the apparatus at least to perform:
providing a first modified three-dimensional pixel array by applying the narrower convolutional operation;
providing a second modified three-dimensional pixel array by applying the wider convolutional operation;
providing a third modified three-dimensional pixel array as a difference between the first modified three-dimensional pixel array and the second modified three-dimensional pixel array; and
providing a fourth modified three-dimensional pixel array by applying the at least one one-dimensional convolution in the third dimension to the third modified three-dimensional pixel array,
wherein each layer of the fourth modified three-dimensional pixel array forms an image in the plurality of images.
Aspect B1. A method for analyzing a biological sample, the method comprising:
determining that a sample chamber contains a first type of biological sample, the sample chamber comprising at least one bottom wall through which an imaging device is configured to image the sample chamber;
providing a plurality of images by controlling the imaging device to, for each depth of a plurality of depths in the sample chamber:
   focus on the respective depth, and
   capture one or more images of one or more fields of view containing the respective depth in the sample chamber;
counting one or more types of constituents in the plurality of images to determine one or more depth distributions of the one or more types of constituents across the plurality of depths, the one or more types of constituents comprising a constituent of interest; and
quantifying the constituent of interest in the biological sample based on the one or more depth distributions and based on one or more depth distribution curves.
Aspect B2. The method of Aspect B1,
wherein the one or more depth distributions cover less than an entire column of the sample chamber, and
wherein the one or more depth distribution curves cover the entire column of the sample chamber.
Aspect B3. The method of Aspect B1 or Aspect B2,
wherein the one or more depth distributions comprise a depth distribution of the constituent of interest, and
wherein the one or more depth distribution curves comprise a fitted curve fitted to the depth distribution of the constituent of interest.
Aspect B4. The method of Aspect B3, wherein the quantifying the constituent of interest in the biological sample comprises:
estimating, based on the fitted curve, a count of the constituent of interest in the entire column of the sample chamber; and
estimating, based on the count of the constituent of interest in the entire column of the sample chamber, a total count of the constituent of interest in the sample chamber.
Aspect B5. The method of Aspect B1 or Aspect B2,
wherein the one or more depth distributions comprise a plurality of depth distributions of the constituent of interest, each of the plurality of depth distributions corresponding to a different time period,
wherein the one or more depth distribution curves comprise a plurality of fitted curves, each of the plurality of fitted curves being fitted to a corresponding one of the plurality of depth distributions of the constituent of interest.
Aspect B6. The method of Aspect B5, wherein the quantifying the constituent of interest in the biological sample comprises:
for each fitted curve of the plurality of fitted curves, estimating, based on the respective fitted curve, a respective count of the constituent of interest in the entire column of the sample chamber;
providing an average of the respective counts as an estimated count of the constituent of interest in the entire column of the sample chamber; and
estimating, based on the average of the respective counts, a total count of the constituent of interest in the sample chamber.
Aspect B7. The method of Aspect B2,
wherein the one or more types of constituents further comprise at least one second constituent which settles faster than the constituent of interest,
wherein the one or more depth distributions comprise a depth distribution of the constituent of interest, and
the method further comprising:
   determining a separation depth above which the constituent of interest is substantially separated from the second constituent, wherein the determining is based on at least one separation criterion.
Aspect B8. The method of Aspect B7, further comprising:
estimating a count of the constituent of interest above the separation depth in the entire column of the sample chamber based on a portion of the first depth distribution above the separation depth;
identifying a reference depth-distribution curve for the constituent of interest corresponding to the first depth distribution, wherein the one or more depth distribution curves comprises the reference depth-distribution curve; and
estimating a count of the constituent of interest below the separation depth in the entire column of the sample chamber based on a portion of the reference depth-distribution curve below the separation depth.
Aspect B9. The method of Aspect B8, wherein the quantifying the constituent of interest in the biological sample comprises:
estimating a total count of the constituent of interest in the entire column of the sample chamber as a sum of:
   the estimated count of the constituent of interest above the separation depth in the entire column of the sample chamber, and
   the estimated count of the constituent of interest below the separation depth in the entire column of the sample chamber.
Aspect B10. The method of Aspect B8 or Aspect B9, wherein the identifying the reference depth-distribution curve for the constituent of interest corresponding to the first depth distribution comprises:
comparing the first depth distribution of the constituent of interest to a plurality of reference depth-distribution curves, each of the plurality of reference depth-distribution curves corresponding to a different time period; and
based on the comparing, selecting a closest match among the plurality of reference depth-distribution curves as the reference depth-distribution curve for the constituent of interest corresponding to the first depth distribution.
Aspect B11. The method of Aspect B10, further comprising:
identifying a reference depth-distribution curve for the second constituent corresponding to the reference depth-distribution curve for the constituent of interest.
Aspect B12. The method of Aspect B11, wherein the determining the separation depth comprises:
applying the at least one separation criterion to the reference depth-distribution curve for the constituent of interest and the reference depth-distribution curve for the second constituent to determine a depth at which the least one separation criterion is satisfied; and
providing the depth at which the least one separation criterion is satisfied as the separation depth.
Aspect B13. The method of any one of Aspect B7 to Aspect B12, further comprising:
detecting, in the plurality of images, at least the constituent of interest and the second constituent by performing object detection on the plurality of images.
Aspect B14. The method of Aspect B2,
wherein the one or more types of constituents further comprise at least one other constituent,
wherein the one or more depth distributions comprise a composite depth distribution of the constituent of interest and the at least one other constituent, and
the method further comprising:
   identifying a composite reference depth-distribution curve for the constituent of interest and the at least one other constituent, the composite reference depth-distribution curve corresponding to the composite depth distribution, wherein the one or more depth distribution curves comprise the composite reference depth-distribution curve.
Aspect B15. The method of Aspect B14, wherein the identifying the composite reference depth-distribution curve for the constituent of interest and the at least one other constituent comprises:
comparing the composite depth distribution to a plurality of composite reference depth-distribution curves, each of the plurality of composite reference depth-distribution curves corresponding to a different time period; and
based on the comparing, selecting a closest match among the plurality of composite reference depth-distribution curves as the composite reference depth-distribution curve for the constituent of interest and the at least one other constituent.
Aspect B16. The method of Aspect B14 or Aspect B15, further comprising:
determining a separation depth above which the constituent of interest is substantially separated from the at least one other constituent, wherein the determining is based on the composite reference depth-distribution curve.
Aspect B17. The method of Aspect B16, further comprising:
estimating a count of the constituent of interest above the separation depth in the entire column of the sample chamber; and
estimating a count of the constituent of interest below the separation depth in the entire column of the sample chamber based on a portion of a reference depth-distribution curve below the separation depth, the reference depth-distribution curve corresponding to the constituent of interest and being associated with the composite reference depth-distribution curve.
Aspect B18. The method of Aspect B1, wherein the quantifying the constituent of interest in the biological sample comprises:
determining that at least one instance of the constituent of interest is in the plurality of images.
Aspect B19. The method of any of the preceding Aspect Bs, wherein the providing the plurality of images comprises:
forming a three-dimensional pixel array based on at least some of the one or more images of the one or more fields of view containing the respective depths of the plurality of depths,
wherein the three-dimensional pixel array comprises a first dimension, a second dimension, and a third dimension.
Aspect B20. The method of Aspect B19, wherein the providing the plurality of images comprises:
applying, for at least a portion of the three-dimensional pixel array, at least one one-dimensional convolution in the first dimension, at least one one-dimensional convolution in the second dimension, and at least one one-dimensional convolution in the third dimension.
Aspect B21. The method of Aspect B19, wherein the providing the plurality of images comprises:
applying, for at least a portion of the three-dimensional pixel array, a narrower convolutional operation in the first dimension and the second dimension, a wider convolutional operation in the first dimension and the second dimension, and at least one one-dimensional convolution in the third dimension.
Aspect B22. The method of Aspect B21, wherein the narrower convolutional operation comprises a first convolution in the first dimension and a second convolution in the second dimension,
wherein the wider convolutional operation comprises a third convolution in the first dimension and a fourth convolution in the second dimension, and
wherein kernels of the first convolution and the second convolution are smaller than kernels of the third convolution and the fourth convolution.
Aspect B23. The method of Aspect B21 of Aspect B22, wherein the applying comprises:
providing a first modified three-dimensional pixel array by applying the narrower convolutional operation;
providing a second modified three-dimensional pixel array by applying the wider convolutional operation;
providing a third modified three-dimensional pixel array as a difference between the first modified three-dimensional pixel array and the second modified three-dimensional pixel array; and
providing a fourth modified three-dimensional pixel array by applying the at least one one-dimensional convolution in the third dimension to the third modified three-dimensional pixel array,
wherein each layer of the fourth modified three-dimensional pixel array forms an image in the plurality of images.
Aspect C1. A processor-readable medium storing instructions which, when executed by at least one processor of an apparatus, causes the apparatus at least to perform:
determining that a sample chamber contains a first type of biological sample, the sample chamber comprising at least one bottom wall through which an imaging device is configured to image the sample chamber;
providing a plurality of images by controlling the imaging device to, for each depth of a plurality of depths in the sample chamber:
   focus on the respective depth, and
   capture one or more images of one or more fields of view containing the respective depth in the sample chamber;
counting one or more types of constituents in the plurality of images to determine one or more depth distributions of the one or more types of constituents across the plurality of depths, the one or more types of constituents comprising a constituent of interest; and
quantifying the constituent of interest in the biological sample based on the one or more depth distributions and based on one or more depth distribution curves.
Aspect C2. The processor-readable medium of Aspect C1,
wherein the one or more depth distributions cover less than an entire column of the sample chamber, and
wherein the one or more depth distribution curves cover the entire column of the sample chamber.
Aspect C3. The processor-readable medium of Aspect C1 or Aspect C2,
wherein the one or more depth distributions comprise a depth distribution of the constituent of interest, and
wherein the one or more depth distribution curves comprise a fitted curve fitted to the depth distribution of the constituent of interest.
Aspect C4. The processor-readable medium of Aspect C3,
wherein in the quantifying the constituent of interest in the biological sample, the instructions, when executed by the at least one processor, cause the apparatus at least to perform:
estimating, based on the fitted curve, a count of the constituent of interest in the entire column of the sample chamber; and
estimating, based on the count of the constituent of interest in the entire column of the sample chamber, a total count of the constituent of interest in the sample chamber.
Aspect C5. The processor-readable medium of Aspect C1 or Aspect C2,
wherein the one or more depth distributions comprise a plurality of depth distributions of the constituent of interest, each of the plurality of depth distributions corresponding to a different time period,
wherein the one or more depth distribution curves comprise a plurality of fitted curves, each of the plurality of fitted curves being fitted to a corresponding one of the plurality of depth distributions of the constituent of interest.
Aspect C6. The processor-readable medium of Aspect C5, wherein in the quantifying the constituent of interest in the biological sample, the instructions, when executed by the at least one processor, cause the apparatus at least to perform:
for each fitted curve of the plurality of fitted curves, estimating, based on the respective fitted curve, a respective count of the constituent of interest in the entire column of the sample chamber;
providing an average of the respective counts as an estimated count of the constituent of interest in the entire column of the sample chamber; and
estimating, based on the average of the respective counts, a total count of the constituent of interest in the sample chamber.
Aspect C7. The processor-readable medium of Aspect C2,
wherein the one or more types of constituents further comprise at least one second constituent which settles faster than the constituent of interest,
wherein the one or more depth distributions comprise a depth distribution of the constituent of interest, and
wherein the instructions, when executed by the at least one processor, further cause the apparatus at least to perform:
   determining a separation depth above which the constituent of interest is substantially separated from the second constituent, wherein the determining is based on at least one separation criterion.
Aspect C8. The processor-readable medium of Aspect C7, wherein the instructions, when executed by the at least one processor, further cause the apparatus at least to perform:
estimating a count of the constituent of interest above the separation depth in the entire column of the sample chamber based on a portion of the first depth distribution above the separation depth;
identifying a reference depth-distribution curve for the constituent of interest corresponding to the first depth distribution, wherein the one or more depth distribution curves comprises the reference depth-distribution curve; and
estimating a count of the constituent of interest below the separation depth in the entire column of the sample chamber based on a portion of the reference depth-distribution curve below the separation depth.
Aspect C9. The processor-readable medium of Aspect C8, wherein in the quantifying the constituent of interest in the biological sample, the instructions, when executed by the at least one processor, cause the apparatus at least to perform:
estimating a total count of the constituent of interest in the entire column of the sample chamber as a sum of:
   the estimated count of the constituent of interest above the separation depth in the entire column of the sample chamber, and
   the estimated count of the constituent of interest below the separation depth in the entire column of the sample chamber.
Aspect C10. The processor-readable medium of Aspect C8 or Aspect C9, wherein in the identifying the reference depth-distribution curve for the constituent of interest corresponding to the first depth distribution, the instructions, when executed by the at least one processor, cause the apparatus at least to perform:
comparing the first depth distribution of the constituent of interest to a plurality of reference depth-distribution curves, each of the plurality of reference depth-distribution curves corresponding to a different time period; and
based on the comparing, selecting a closest match among the plurality of reference depth-distribution curves as the reference depth-distribution curve for the constituent of interest corresponding to the first depth distribution.
Aspect C11. The processor-readable medium of Aspect C10, wherein the instructions, when executed by the at least one processor, further cause the apparatus at least to perform:
identifying a reference depth-distribution curve for the second constituent corresponding to the reference depth-distribution curve for the constituent of interest.
Aspect C12. The processor-readable medium of Aspect C11, wherein in the determining the separation depth, the instructions, when executed by the at least one processor, cause the apparatus at least to perform:
applying the at least one separation criterion to the reference depth-distribution curve for the constituent of interest and the reference depth-distribution curve for the second constituent to determine a depth at which the least one separation criterion is satisfied; and
providing the depth at which the least one separation criterion is satisfied as the separation depth.
Aspect C13. The processor-readable medium of any one of Aspect C7 to Aspect C12, wherein the instructions, when executed by the at least one processor, further cause the apparatus at least to perform:
detecting, in the plurality of images, at least the constituent of interest and the second constituent by performing object detection on the plurality of images.
Aspect C14. The processor-readable medium of Aspect C2,
wherein the one or more types of constituents further comprise at least one other constituent,
wherein the one or more depth distributions comprise a composite depth distribution of the constituent of interest and the at least one other constituent, and
wherein the instructions, when executed by the at least one processor, further cause the apparatus at least to perform:
   identifying a composite reference depth-distribution curve for the constituent of interest and the at least one other constituent, the composite reference depth-distribution curve corresponding to the composite depth distribution, wherein the one or more depth distribution curves comprise the composite reference depth-distribution curve.
Aspect C15. The processor-readable medium of Aspect C14, wherein in the identifying the composite reference depth-distribution curve for the constituent of interest and the at least one other constituent, the instructions, when executed by the at least one processor, cause the apparatus at least to perform:
comparing the composite depth distribution to a plurality of composite reference depth-distribution curves, each of the plurality of composite reference depth-distribution curves corresponding to a different time period; and
based on the comparing, selecting a closest match among the plurality of composite reference depth-distribution curves as the composite reference depth-distribution curve for the constituent of interest and the at least one other constituent.
Aspect C16. The processor-readable medium of Aspect C14 or Aspect C15, wherein the instructions, when executed by the at least one processor, further cause the apparatus at least to perform:
determining a separation depth above which the constituent of interest is substantially separated from the at least one other constituent, wherein the determining is based on the composite reference depth-distribution curve.
Aspect C17. The processor-readable medium of Aspect C16, wherein the instructions, when executed by the at least one processor, further cause the apparatus at least to perform:
estimating a count of the constituent of interest above the separation depth in the entire column of the sample chamber; and
estimating a count of the constituent of interest below the separation depth in the entire column of the sample chamber based on a portion of a reference depth-distribution curve below the separation depth, the reference depth-distribution curve corresponding to the constituent of interest and being associated with the composite reference depth-distribution curve.
Aspect C18. The processor-readable medium of Aspect C1, wherein in the quantifying the constituent of interest in the biological sample, the instructions, when executed by the at least one processor, cause the apparatus at least to perform:
determining that at least one instance of the constituent of interest is in the plurality of images.
Aspect C19. The processor-readable medium of any of the preceding Aspect Cs, wherein in providing the plurality of images, the instructions, when executed by the at least one processor, cause the apparatus at least to perform:
forming a three-dimensional pixel array based on at least some of the one or more images of the one or more fields of view containing the respective depths of the plurality of depths,
wherein the three-dimensional pixel array comprises a first dimension, a second dimension, and a third dimension.
Aspect C20. The processor-readable medium of Aspect C19, wherein in providing the plurality of images, the instructions, when executed by the at least one processor, cause the apparatus at least to perform:
applying, for at least a portion of the three-dimensional pixel array, at least one one-dimensional convolution in the first dimension, at least one one-dimensional convolution in the second dimension, and at least one one-dimensional convolution in the third dimension.
Aspect C21. The processor-readable medium of Aspect C19, wherein in providing the plurality of images, the instructions, when executed by the at least one processor, cause the apparatus at least to perform:
applying, for at least a portion of the three-dimensional pixel array, a narrower convolutional operation in the first dimension and the second dimension, a wider convolutional operation in the first dimension and the second dimension, and at least one one-dimensional convolution in the third dimension.
Aspect C22. The processor-readable medium of Aspect C21, wherein the narrower convolutional operation comprises a first convolution in the first dimension and a second convolution in the second dimension,
wherein the wider convolutional operation comprises a third convolution in the first dimension and a fourth convolution in the second dimension, and
wherein kernels of the first convolution and the second convolution are smaller than kernels of the third convolution and the fourth convolution.
Aspect C23. The processor-readable medium of Aspect C21 of Aspect C22, wherein in the applying, the instructions, when executed by the at least one processor, cause the apparatus at least to perform:
providing a first modified three-dimensional pixel array by applying the narrower convolutional operation;
providing a second modified three-dimensional pixel array by applying the wider convolutional operation;
providing a third modified three-dimensional pixel array as a difference between the first modified three-dimensional pixel array and the second modified three-dimensional pixel array; and
providing a fourth modified three-dimensional pixel array by applying the at least one one-dimensional convolution in the third dimension to the third modified three-dimensional pixel array,
wherein each layer of the fourth modified three-dimensional pixel array forms an image in the plurality of images.

The embodiments disclosed herein are examples of the disclosure and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an embodiment,” “in embodiments,” “in various embodiments,” “in some embodiments,” or “in other embodiments” may each refer to one or more of the same or different embodiments in accordance with the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

The systems, devices, and/or servers described herein may utilize one or more processors to receive various information and transform the received information to generate an output. The processors may include any type of computing device, computational circuit, or any type of controller or processing circuit capable of executing a series of instructions that are stored in a memory. The processor may include multiple processors and/or multicore central processing units (CPUs) and may include any type of device, such as a microprocessor, graphics processing unit (GPU), digital signal processor, microcontroller, programmable logic device (PLD), field programmable gate array (FPGA), or the like. The processor may also include a memory to store data and/or instructions that, when executed by the one or more processors, causes the one or more processors (and/or the systems, devices, and/or servers they operate in) to perform one or more methods, operations, and/or algorithms.

Any of the herein described methods, operations, programs, algorithms or codes may be converted to, or expressed in, a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, Delphi, Fortran, Java, JavaScript, machine code, operating system command languages, Pascal, Perl, PLI, Python, scripting languages, Visual Basic, metalanguages which themselves specify programs, and all first, second, third, fourth, fifth, or further generation computer languages. Also included are database and other data schemas, and any other meta-languages. No distinction is made between languages which are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

It should be understood that the foregoing description is only illustrative of the present disclosure. Various alternatives and modifications can be devised by those skilled in the art without departing from the disclosure. Accordingly, the present disclosure is intended to embrace all such alternatives, modifications and variances. The embodiments described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed:

1. An apparatus for analyzing a biological sample, the apparatus comprising:
at least one processor; and
at least one memory storing instructions which, when executed by the at least one processor, cause the apparatus at least to perform:
determining that a sample chamber contains a first type of biological sample, the sample chamber comprising at least one bottom wall through which an imaging device is configured to image the sample chamber;
providing a plurality of images by controlling the imaging device to, for each depth of a plurality of depths in the sample chamber:
focus on the respective depth, and
capture one or more images of one or more fields of view containing the respective depth in the sample chamber;
counting one or more types of constituents in the plurality of images to determine one or more depth distributions of the one or more types of constituents across the plurality of depths, the one or more types of constituents comprising a constituent of interest; and
quantifying the constituent of interest in the biological sample based on the one or more depth distributions and based on one or more depth distribution curves.

2. The apparatus of claim 1,
wherein the one or more depth distributions cover less than an entire column of the sample chamber, and
wherein the one or more depth distribution curves cover the entire column of the sample chamber.

3. The apparatus of claim 1,
wherein the one or more depth distributions comprise a depth distribution of the constituent of interest, and
wherein the one or more depth distribution curves comprise a fitted curve fitted to the depth distribution of the constituent of interest.

4. The apparatus of claim 3,
wherein in the quantifying the constituent of interest in the biological sample, the instructions, when executed by the at least one processor, cause the apparatus at least to perform:
estimating, based on the fitted curve, a count of the constituent of interest in the entire column of the sample chamber; and
estimating, based on the count of the constituent of interest in the entire column of the sample chamber, a total count of the constituent of interest in the sample chamber.

5. The apparatus of claim 1,
wherein the one or more depth distributions comprise a plurality of depth distributions of the constituent of interest, each of the plurality of depth distributions corresponding to a different time period,
wherein the one or more depth distribution curves comprise a plurality of fitted curves, each of the plurality of fitted curves being fitted to a corresponding one of the plurality of depth distributions of the constituent of interest.

6. The apparatus of claim 5, wherein in the quantifying the constituent of interest in the biological sample, the instructions, when executed by the at least one processor, cause the apparatus at least to perform:
for each fitted curve of the plurality of fitted curves, estimating, based on the respective fitted curve, a respective count of the constituent of interest in the entire column of the sample chamber;
providing an average of the respective counts as an estimated count of the constituent of interest in the entire column of the sample chamber; and
estimating, based on the average of the respective counts, a total count of the constituent of interest in the sample chamber.

7. A method for analyzing a biological sample, the method comprising:
determining that a sample chamber contains a first type of biological sample, the sample chamber comprising at least one bottom wall through which an imaging device is configured to image the sample chamber;
providing a plurality of images by controlling the imaging device to, for each depth of a plurality of depths in the sample chamber:
focus on the respective depth, and
capture one or more images of one or more fields of view containing the respective depth in the sample chamber;
counting one or more types of constituents in the plurality of images to determine one or more depth distributions of the one or more types of constituents across the plurality of depths, the one or more types of constituents comprising a constituent of interest; and
quantifying the constituent of interest in the biological sample based on the one or more depth distributions and based on one or more depth distribution curves.

8. The method of claim 7,
wherein the one or more depth distributions cover less than an entire column of the sample chamber, and
wherein the one or more depth distribution curves cover the entire column of the sample chamber.

9. The method of claim 7,
wherein the one or more depth distributions comprise a depth distribution of the constituent of interest, and
wherein the one or more depth distribution curves comprise a fitted curve fitted to the depth distribution of the constituent of interest.

10. The method of claim 9, wherein the quantifying the constituent of interest in the biological sample comprises:
estimating, based on the fitted curve, a count of the constituent of interest in the entire column of the sample chamber; and
estimating, based on the count of the constituent of interest in the entire column of the sample chamber, a total count of the constituent of interest in the sample chamber.

11. The method of claim 7,
wherein the one or more depth distributions comprise a plurality of depth distributions of the constituent of interest, each of the plurality of depth distributions corresponding to a different time period,
wherein the one or more depth distribution curves comprise a plurality of fitted curves, each of the plurality of fitted curves being fitted to a corresponding one of the plurality of depth distributions of the constituent of interest.

12. The method of claim 11, wherein the quantifying the constituent of interest in the biological sample comprises:
for each fitted curve of the plurality of fitted curves, estimating, based on the respective fitted curve, a respective count of the constituent of interest in the entire column of the sample chamber;
providing an average of the respective counts as an estimated count of the constituent of interest in the entire column of the sample chamber; and
estimating, based on the average of the respective counts, a total count of the constituent of interest in the sample chamber.

13. A processor-readable medium storing instructions which, when executed by at least one processor of an apparatus, causes the apparatus at least to perform:
determining that a sample chamber contains a first type of biological sample, the sample chamber comprising at least one bottom wall through which an imaging device is configured to image the sample chamber;
providing a plurality of images by controlling the imaging device to, for each depth of a plurality of depths in the sample chamber:
focus on the respective depth, and
capture one or more images of one or more fields of view containing the respective depth in the sample chamber;
counting one or more types of constituents in the plurality of images to determine one or more depth distributions of the one or more types of constituents across the plurality of depths, the one or more types of constituents comprising a constituent of interest; and
quantifying the constituent of interest in the biological sample based on the one or more depth distributions and based on one or more depth distribution curves.

14. The processor-readable medium of claim 13,
wherein the one or more depth distributions cover less than an entire column of the sample chamber, and
wherein the one or more depth distribution curves cover the entire column of the sample chamber.

15. The processor-readable medium of claim 13,
wherein the one or more depth distributions comprise a depth distribution of the constituent of interest, and
wherein the one or more depth distribution curves comprise a fitted curve fitted to the depth distribution of the constituent of interest.

16. The processor-readable medium of claim 15,
wherein in the quantifying the constituent of interest in the biological sample, the instructions, when executed by the at least one processor, cause the apparatus at least to perform:
estimating, based on the fitted curve, a count of the constituent of interest in the entire column of the sample chamber; and
estimating, based on the count of the constituent of interest in the entire column of the sample chamber, a total count of the constituent of interest in the sample chamber.

17. The processor-readable medium of claim 13,
wherein the one or more depth distributions comprise a plurality of depth distributions of the constituent of interest, each of the plurality of depth distributions corresponding to a different time period,
wherein the one or more depth distribution curves comprise a plurality of fitted curves, each of the plurality of fitted curves being fitted to a corresponding one of the plurality of depth distributions of the constituent of interest.

18. The processor-readable medium of claim 17, wherein in the quantifying the constituent of interest in the biological sample, the instructions, when executed by the at least one processor, cause the apparatus at least to perform:
for each fitted curve of the plurality of fitted curves, estimating, based on the respective fitted curve, a respective count of the constituent of interest in the entire column of the sample chamber;
providing an average of the respective counts as an estimated count of the constituent of interest in the entire column of the sample chamber; and
estimating, based on the average of the respective counts, a total count of the constituent of interest in the sample chamber.
